(19) United States
(12) Patent Application Publication
(10) Pub. No.: US 2010/0306020 A1
(43) Pub. Date: Dec. 2, 2010

(54) SYSTEM AND METHOD FOR WORKFLOW MANAGEMENT WITH CONFIGURABLE STATES AND EXTENSIBILITY

(75) Inventors: Arthur Pui Wing Lo, Richmond (CA); Patrick-Alain Joseph Numainville, Burnaby (CA); Kenny Wai-doon Louie, Burnaby (CA); Vernon Joseph Chin, Burnaby (CA); William Tak-Chou Lee, Richmond (CA); Shuk Yee Wendy Lee, Richmond (CA); Donald Edward Marquardt, Vancouver (CA)

Correspondence Address: Nixon Peabody LLP, P.O. Box 60610, Palo Alto, CA, 94306, US

(73) Assignee: Clevest Solutions, Inc., Richmond (CA)

(21) Appl. No.: 12/479,704

(22) Filed: Jun. 5, 2009

(30) Foreign Application Priority Data
May 27, 2009 (CA) 2,667,036
May 27, 2009 (CA) 12479704
May 27, 2009 (WO) 12479704

(51) Int. Cl. G06Q 10/00; G06F 3/048; G06F 17/30

(52) U.S. Cl. 705/9; 715/810; 715/772; 715/764; 707/E17.044

(57) ABSTRACT

A workflow management system provides a GUI configuration tool that allows end users to configure the states and state properties of workflows and workers without rewriting the program. The application also provides an interface that allows the use of extensible code to perform custom functions at particular states and at particular state transitions of a workflow.

### CROSS REFERENCE TO RELATED APPLICATIONS or PRIORITY CLAIM

This application claims priority to International Application No. PCT/CA2009/______, entitled “A SYSTEM AND METHOD FOR WORKFLOW MANAGEMENT WITH CONFIGURABLE STATES AND EXTENSIBILITY”, which was filed on May 27, 2009, and also claims priority to Canadian Patent Application No. ______, filed May 27, 2009.

### FIELD OF INVENTION

The present invention relates to workflow management systems, and in particular a method and system for end users to configure workflows.

### BACKGROUND OF THE INVENTION

Workflow management systems are used by many businesses to increase productivity and efficiency by assisting and automating the processing of work orders. The sequence of actions and decision logic within the processing life cycle of a work order is referred to as a “workflow”. Workflow management systems are used across many different industries, such as utilities, logistics, manufacturing, and the financial industry.

Essential to workflow management systems is the ability to identify and provide information regarding the different processing states of work orders within a processing life cycle, which are referred to as “order states”, or simply “states”. End users and automated workflow systems define and identify the various order states so that the timely execution of decision logic and operations occur at the appropriate order states and processing points of a workflow.

A business employs methods of processing work orders that are specific to their industry, products, services, organizational structure and business plans. Therefore, the processing life cycle of a work order and the way that order states are defined differ from business to business.

To accommodate the specific processing methods of each business, workflow management systems are typically created as custom applications. These custom applications are designed to support the specific requirements of a business as defined at a particular point in time. However, as business plans and processes change, skilled programmers are required to rewrite and recompile the application to incorporate modifications to the system. Changes to the system are thus slow and costly to implement.

Changes in business processes may require redefining the order states and state properties of a workflow. Modifying the number of order states and state properties usually involves extensive rewriting of the custom application. In addition to modifying the number of order states and state definitions, programmers must also rewrite the decision logic to accommodate the newly added or deleted states and to determine appropriate state transitions where multiple state transitions are available. Redefining the number of order states and state definitions also requires the programming of relevant transitory inputs, also referred to as “triggers”, that catalyze state transitions and execution of particular decision logic and particular operations. The work involved in redefining and programming these triggers is extensive in cases where business workflows require the triggers to be generated from multiple sources within the workflow system, and involve a multitude of user types, such as hosts, dispatchers, administrators, workers, and mobile workers.

Workflows may also involve numerous actions that are performed prior, during, and after a state transition by multiple elements and participants within a workflow system. Changes to business processes may require programmers to rewrite the custom application to modify the actions that are involved for each of the relevant elements and participants of the system.

Representing order states within a workflow management system helps users identify the processing state of a work order within the processing life cycle. Complex programming is typically required to represent a multitude of order states within a workflow. Methods of representing order states typically include text, colours, and graphic icons that are presented on client devices to distinguish each state. Additional complexity is involved in cases where particular order states must be represented differently for each user type or programmed specifically for each type of client device. A custom application will require programmers to ensure that all new and modified states are appropriately represented and programmed for the relevant users of the system.

Workflow systems typically employ means of notifying users of particular state transitions. Notification methods may be in the form of computer display messages, sound alerts, emails, mobile phone text messages, or automated phone calls. Various order states and different user types of the system may require a distinct form of notification. Adding or modifying order states to or in a workflow in a custom application requires programmers to rewrite the application to include the appropriate forms of notifications of each order state for each user type.

During rewriting of custom applications to accommodate order state modifications in a workflow the likelihood of errors increases. Programming, testing and further revisions cause additional down time of the system.

### SUMMARY OF THE INVENTION

The system and method according to the invention provides a workflow management application that readily accommodates the changing needs of all types of businesses, by enabling order states and state properties to be configured by the end user. The system enables users to reconfigure the system without suffering from downtime.

The system is also extensible in terms of integrating third party hardware and software to perform specific functions necessary to a particular business process. A means of integrating third party hardware and custom code to allow customer specific functions and features to be executed at particular order states and state transitions increases the effectiveness and flexibility of the system.

The workflow management system according to an embodiment of the invention provides a Graphical User Interface (GUI) tool that enables a user to configure order states, states transitions, state properties and the associated decision logic, and actions. The system provided herein is also capable of configuring the worker types and worker statuses to indicate the states and statuses of workers that are involved in a workflow. The workflow management system also integrates third party hardware and software functionality to be implemented at particular order states or state transitions of a workflow.

The method and system according to the invention allows end users to configure the states, properties, actions and transitions of workflows, and the worker types and worker status properties without the need to rewrite the workflow application. The system according to the invention also enables a workflow management system to use extensible code to perform custom functions at particular states and at particular state transitions of a workflow.

The workflow management system and method according to the invention assists in the management of resources that include a workforce, and the efficient and accurate performance of business processes. Business processes, also called work projects, workflows, or work orders, may involve multiple tasks and sub-projects.

A business entity may have many business processes with unique operations and requirements that need to be accommodated by the workflow management system. The different business processes of each business entity can be clearly understood and mapped by a flowchart. A flow chart may be used to model and identify the various processing states of a work order within a processing life cycle, and the decision logic and operations that correspond to each processing state. Processing states may also be referred to herein as “order states” or simply “states”.

The present invention provides a workflow management system with a GUI tool that enables a user to create the order states and decision logic of a business process. The GUI tool provides graphical elements enabling a user to create or modify the order states, decision logic and state transitions of a business process in the form of a graphic diagram, which is referred to herein as a “state flow”. The GUI tool enables a user to create or configure a state flow that represents a one-to-one mapping of a business process flowchart. The GUI tool also enables a user to create or edit the state flow, and simultaneously view, create or edit the decision logic that determines the appropriate order state transitions, which is referred to herein as “state flow logic”. The GUI tool also enables a user to simultaneously view, create or edit the properties and operations of each order state.

The GUI tool also enables users to create or edit the various worker types, worker statuses, and worker state representations for individuals that participate in the business process. Worker statuses and worker states are used by the system, dispatchers and/or administrators to identify various states of worker activity and worker conditions to assist in the management of worker resources and worker activities.

The user friendly design of the GUI tool allows a user to implement the tool without the need for advanced programming knowledge. The GUI tool provides a context sensitive menu of graphic options for users to create or edit state flows in the form of a graphic diagram. The GUI tool also provides a context sensitive menu of functions, operators, fields, and variables, in a user friendly spoken language syntax for users to create or edit the state flow logic. The GUI tool's context sensitive menu effectively prevents users from making syntactic errors during the process of creating or editing the state flow and the state flow logic statements. Therefore, the GUI tool is able to offer users the flexibility of creating and editing order states and state flow logic while preventing syntactic errors from disrupting the system.

The system according to an embodiment of the invention integrates changes to state flows, order states, state flow logic, worker types, and worker statuses in an application without requiring re-writing and recompiling of the application. Users can therefore make changes to state flows, order states, state flow logic, worker types, and worker statuses without interrupting the operability of the workflow management system at any time, and without causing any downtime.

In an embodiment of the invention, a GUI program is provided for editing order states and state flows, including a GUI tool displaying, simultaneously: a screen area wherein the state flow is editable; a menu of graphic options that include arrows, broken line arrows, and predefined shapes that represent order states, state transitions, temporal transitions, and state flow logic, for users to create or edit the state flow; a screen area wherein state flow logic is editable; a menu of data fields and repeatable fields useable to create state flow logic statements for the state flow; a screen area providing a context sensitive menu of a plurality of state flow logic components presented in a spoken language syntax for use in editing the state flow logic; a screen area wherein order states are editable; and a screen area wherein worker types are editable; and a screen area wherein worker statuses are editable.

The state flow may be editable by inclusion of order states in a database and accessible by the graphical user interface tool. The state flow logic may be further editable by replacing a state flow statement with a new state flow statement. The state flow may be further editable to include a plurality of, and arrangement of, order states. The state flow may yet be further editable by generation of a new state flow statement and inclusion of a previously or newly added order state of the database.

The state flow may be further editable by generation of state flow logic by including an arrangement of operators, functions and fields provided within a context sensitive menu.

The state flow may be further editable by provision of a construct for applying a while loop. The construct for applying a logic test to all fields may be in a repeatable, and all fields within the repeatable that are one level nested within the repeatable.

A system for dynamically integrating a state flow with an application program is provided, the system including an application program for executing the state flow; a database storing a plurality of fields and a plurality of repeatable fields, and an executable construct corresponding to a business process; a graphical user interface tool providing, to a user, a screen area for creation of order states for the business process; a screen area for creation of state flows using: a menu of graphic options that include arrows, broken line arrows, and predefined shapes that represent order states, state transitions, temporal transitions, and decision logic; and a screen area for creation of state flow logic using: a plurality of defined functions, a plurality of logic operators, a plurality of key-words, and the plurality of fields.

The graphical user interface tool may make available a new or modified order state, worker type, worker status, field or repeatable field, as the new or modified order state, worker type, worker status, field, or repeatable field is added to the database. The plurality of order states, worker types, worker statuses, fields and repeatable fields may be stored as Extensible Markup Language (XML) code in the database.

The graphical user interface (GUI) configuration tool presented herein enables the configuration of order state properties that include action trigger buttons, action trigger keys, decision logic, server actions, and methods of representing the order states to multiple types of client devices that may be available for use by different user types of the workflow system.

Order state properties and the state flow for each business process is organized as a part of a data entity referred to as an “Order Type”. An Order Type defines the order states, state flow, workflow screens, workflow logic, data fields, and value lists for each business process. The dispatcher tool and mobile applications may process the information within an Order Type in a structured fashion.

The GUI program also allows the creating and editing of worker types, and worker statuses that are linked to orders states and state flows of a business process. Worker type and worker status details are organized as a part of a data entity referred to as a “Worker Type”. A Worker Type defines the worker types and worker statuses for a business process.

The representation of state flow and state flow logic may be presented in a spoken language syntax convertible into XML code stored in the database and made available to the application. Likewise, a representation of order states, worker types and worker statuses may be converted into XML code that is stored in the database and made available to the application.

The method of using Order Types and Worker Types to organize information for each business process enables information to be supplied to a dispatcher tool and workers' mobile devices on an as-needed basis. Organizing the information by Order Types and Worker Types, and the partitioning of the information, reduces the complexity of the logic and allows the information to be processed on mobile devices that have limited memory and processing capabilities.

Users of the system may use the GUI tool to create and manipulate Order Type and Worker Type information, including order states, state flows, worker types, and worker statuses and use the information as part of the workflow management system without having to create custom code or recompile any parts of the application.

The workflow management system presented herein also provides a method of extensibility that allows the use of extensible code to execute custom functions that include the use of third party hardware and software at particular order states or state transitions. The system provides a published interface to integrate and implement custom functions of third party hardware and software, and consume web services that are outside of the workflow management system. A software interface is provided to link the workflow management system with external hardware and software and allow data to be queried from and returned to the system.

The system integrates extensible code to allow customer specific functions to be executed within the system without having to rewrite the main codestream of the application. The use of published interfaces allow both the extensible code and the main codestream to be independently upgraded or modified and remain mutually compatible. Therefore, customer specific extensible code does not need to be rewritten when upgrades or modifications are made to the system.

Other advantages of the present invention will become apparent from the detailed description of the invention and the illustrations provided herein.

### BRIEF DESCRIPTION OF THE DRAWINGS

FIG. 1 illustrates a block diagram of a computing environment in which the present invention may be implemented according to an embodiment;

FIG. 2 illustrates an example of a business process life cycle;

FIG. 3 illustrates a state flow based on the business process life cycle of FIG. 2;

FIG. 4 illustrates the State Flow Editor screen area of the GUI configuration tool in an embodiment of the invention;

FIG. 5 illustrates the Order State Editor screen area of the GUI configuration tool in an embodiment of the invention;

FIG. 6 illustrates the use of the Order State Editor for the configuration of the “Working” state's Basic Attributes, and the Order Summary Presentation and Worker Summary Presentation sub-screens in an embodiment of the invention;

FIG. 7 illustrates a screen area provided by the GUI configuration tool for configuring worker state icons in an embodiment of the invention;

FIG. 8 illustrates the use of the Order State Editor for the configuration of the Working state's Action Triggers—Clients sub-screen in an embodiment of the invention;

FIG. 9 illustrates the configuration of state flow logic through the State Flow Logic Editor in an embodiment of the invention;

FIG. 10 illustrates the configuration of state transitions through the State Flow Logic Editor in an embodiment of the invention;

FIG. 11 illustrates the properties that may be configured through the Order State Editor's Basic Attributes screen area, Order Summary Presentation sub-screen, and Worker Summary Presentation sub-screen for the “Default” state in an embodiment of the invention;

FIG. 12 illustrates the properties that may be configured through the Action Triggers Clients sub-screen for the “Default” state in an embodiment of the invention;

FIG. 13 illustrates the properties that may be configured through the Action Triggers Server sub-screen, and Action Triggers Host sub-screen for the “Default” state in an embodiment of the invention;

FIG. 14 illustrates the properties that may be configured through the Basic Attributes screen area and Order Summary Presentation sub-screen for the “Unassigned” state in an embodiment of the invention;

FIG. 15 illustrates the properties that may be configured through the Action Triggers Clients sub-screen for the “Unassigned” state in an embodiment of the invention;

FIG. 16 illustrates the properties that may be configured through the Action Triggers Clients sub-screen for the “Assigned” state in an embodiment of the invention;

FIG. 17 illustrates the properties that may be configured through the Basic Attributes screen area for the “Working” state in an embodiment of the invention;

FIG. 18 illustrates the properties that may be configured through the Action Triggers Clients sub-screen for the “Working” state in an embodiment of the invention;

FIG. 19 illustrates the properties that may be configured through the Basic Attributes screen area for the “Completed” state in an embodiment of the invention;

FIG. 20 illustrates the properties that may be configured through the Basic Attributes screen area for the “Problematic” state in an embodiment of the invention;

FIG. 21 illustrates the properties that may be configured through the Action Triggers Clients sub-screen for the “Problematic” state in an embodiment of the invention;

FIG. 22 illustrates the properties that may be configured through the Action Triggers Server sub-screen for the “Problematic” state in an embodiment of the invention;

FIG. 23 illustrates the transitions of order states and worker states within a state flow in an embodiment of the invention;

FIG. 24 illustrates a modified state flow that includes a “Call Ahead” state in an embodiment of the invention;

FIG. 25 illustrates properties that may be configured through the Basic Attributes screen area for the “Call Ahead” state in an embodiment of the invention;

FIG. 26 illustrates properties that may be configured through the Action Triggers Clients sub-screen for the “Call Ahead” state in an embodiment of the invention;

FIG. 27 illustrates the configuration of optional actions through the Action Triggers Clients sub-screen for the Laptop worker type in the “Working” state in an embodiment of the invention;

FIG. 28 illustrates the configuration of multiple worker actionable transitions for the Laptop user type through the Order State Editor's Action Triggers Clients sub-screen in an embodiment of the invention;

FIG. 29 shows source code for defining a state flow within and Order Type in an embodiment of the invention;

FIG. 30 shows source code that illustrates the methodology for defining order state properties within an Order Type in an embodiment of the invention;

FIG. 31 illustrates worker states and worker status graphic icons in an embodiment of the invention;

FIG. 32 illustrates the worker status options that are provided on a laptop device in an embodiment of the invention;

FIG. 33 illustrates the Worker Detail Editor screen area of the GUI configuration tool in an embodiment of the invention;

FIG. 34 illustrates the state flow logic of work orders that involve multiple workers in an embodiment of the invention; and

FIG. 35 shows examples and definitions of published interfaces employed by the system in an embodiment of the invention.

### DETAILED DESCRIPTION OF AN ILLUSTRATIVE EMBODIMENT

The invention and its principles presented herein may be produced with many different configurations, forms and design elements. The drawings, illustrations and description of the invention herein are described with the understanding that the present disclosure is to be considered as an example of the principles of the invention and is not intended to limit the invention to the embodiment illustrated. Those skilled in the art will envision many possible variations within the scope of the present invention. To better appreciate the present invention it will be illustrated in an example embodiment within the context of managing mobile workers in the electric utilities industry.

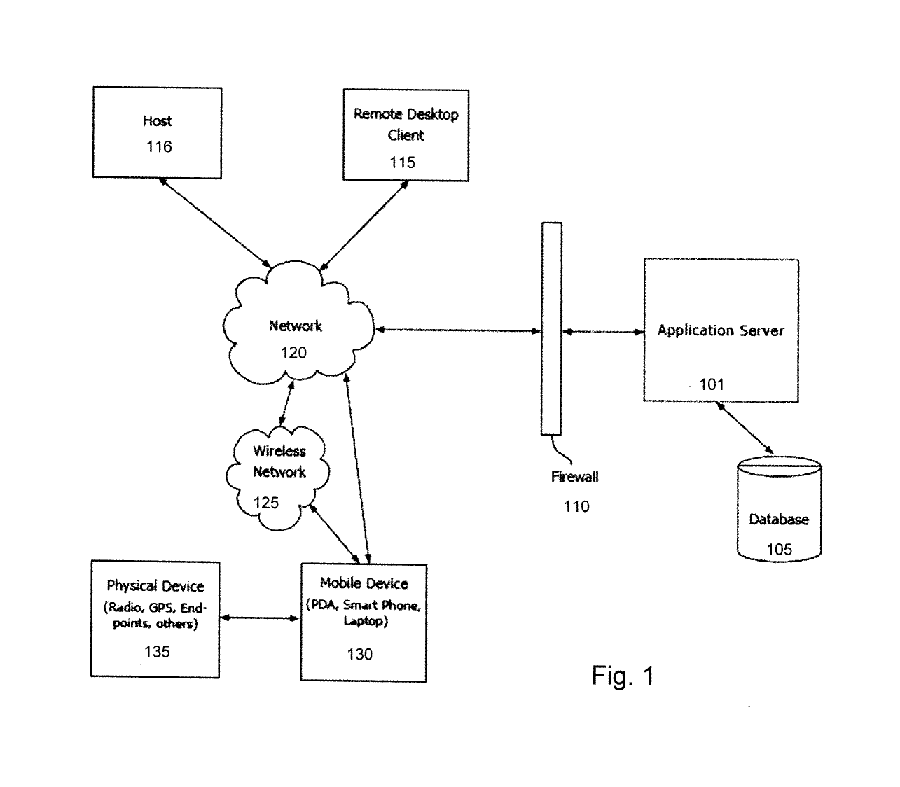

FIG. 1 shows an example of computing environment in which the present invention may be implemented. Those skilled in the art will appreciate that the workflow management system may be implemented with other computer system configurations.

Remote desktop clients 115 or a host 116 and wireless mobile clients 130 may access server 101 and database 105 through a wireless network 125, or a network such as the Internet 120. Host 116 provides and receives information regarding work orders to and from the application on server 101. Mobile devices 130 include portable computing devices that are capable of sending and receiving messages over a wireless network or devices that work in a disconnected mode and send and receive information when a network connection is established. Mobile devices, which may also be client devices, may include cellular phones, smart phones, Personal Digital Assistants (PDAs), handheld computers, laptop computers, tablet computers, and the like. Mobile devices 130 may include at least one other client application configured to receive content from third party computing devices or physical devices 135 that are outside of the workflow management system. Database 105 is used to store information related to data fields, workflow logic and application screens.

Server 101, host 116 and client 115 may be conventional computers, with input means, such as a keyboard, mouse and network connections; output means, such as a monitor, and the network connection; one or more processors; and memory.

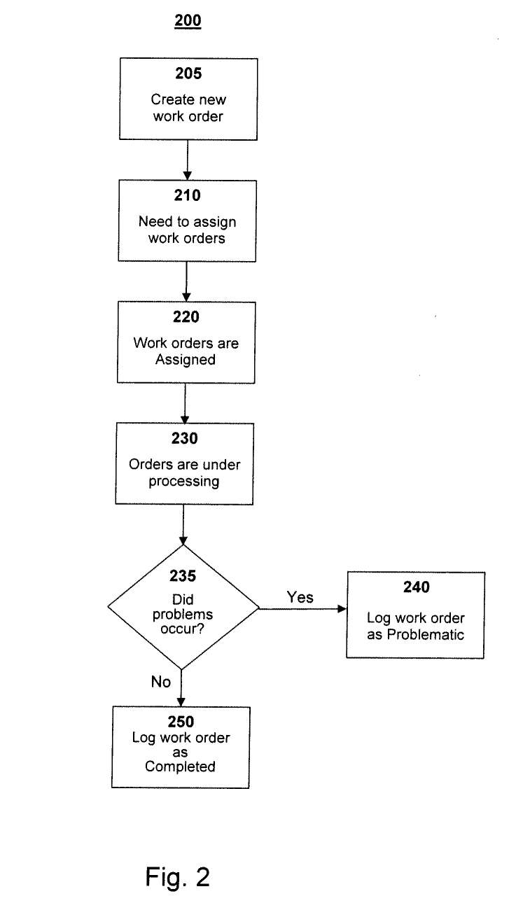

Referring to FIG. 2, work orders and/or work projects undergo a business process life cycle, also referred to as a workflow, which can be represented by a flowchart 200. The flowchart 200 defines and maps the individual processing states that may be required in the course of executing a workflow.

FIG. 2 illustrates an example of a business process life cycle for work orders that may be executed in an electric utility company.

Work orders 205 may be created when a service request is received and is entered into the system. A dispatcher or automated scheduler then assigns the work orders to appropriate workers for processing 210. The dispatcher or automated scheduler ensures that all unassigned work orders are assigned to workers 220. Workers then process their assigned work orders 230 and indicate the completion of each work order when the required business processes have been completed 250. If problems occur during the processing of work orders 235, the work order is noted as problematic 240.

The workflow management system presented herein provides a GUI configuration tool allowing a user to dynamically configure a “state flow”, which includes the order states and state transitions of a business process lifecycle. The configuration tool allows users to configure state flows that represent the business process lifecycle as defined and mapped by a flowchart.

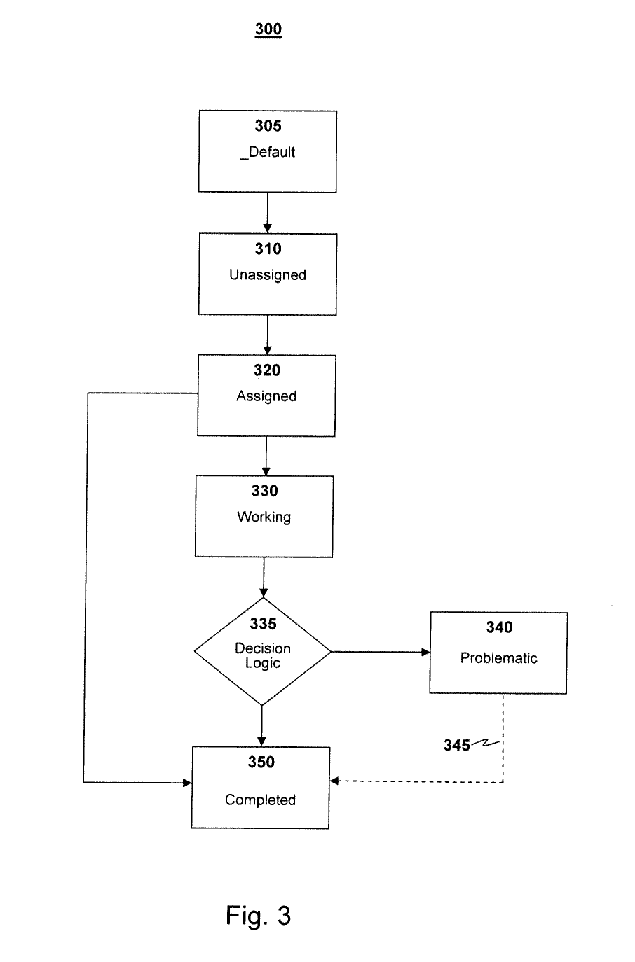

FIG. 3 illustrates a state flow that may be created by the GUI configuration tool, representing flowchart 200 in FIG. 2. Newly generated work orders are defined with a “_Default” state 305 when they are initiated within the workflow management system. New “_Default” work orders then transition to an “Unassigned” order state 310. A dispatcher working with the system may then assign the “Unassigned” work orders to suitable workers. Work orders that have been assigned to workers transition to an “Assigned” state 320. When a worker begins to process an “Assigned” work order the order state transitions to a “Working” state 330. When the worker completes the actions that are required for the “Working” state 330, decision logic 335 is executed to determine whether the work order has been processed according to specified parameters. If a work order has been processed within parameters the work order transitions to a “Completed” state 350. If a work order has not been processed according to the specified parameters the work order transitions to a “Problematic” state 340. The system is configured with a temporal trigger 345 that transitions “Problematic” work orders 340 to the “Completed” state 350 after a specified time interval. These temporal triggers enable the system to perform functions, including state transitions, that are qualified with intervals of time. A dispatcher may also directly transition a work order from the “Assigned” state 320 directly to the “Completed” state 350.

The GUI configuration tool according to the invention provides: a screen area with a State Flow Editor 370 allowing the user to create and edit a graphic representation of state flow 300 as defined by flowchart 200; a screen area with a State Flow Logic Editor 380 to create and edit the decision logic within state flow 300; and a screen area with an Order State Editor 400 to allow a user to view, create and edit the order states, order state properties, decision logic, actions and functions within state flow 300.

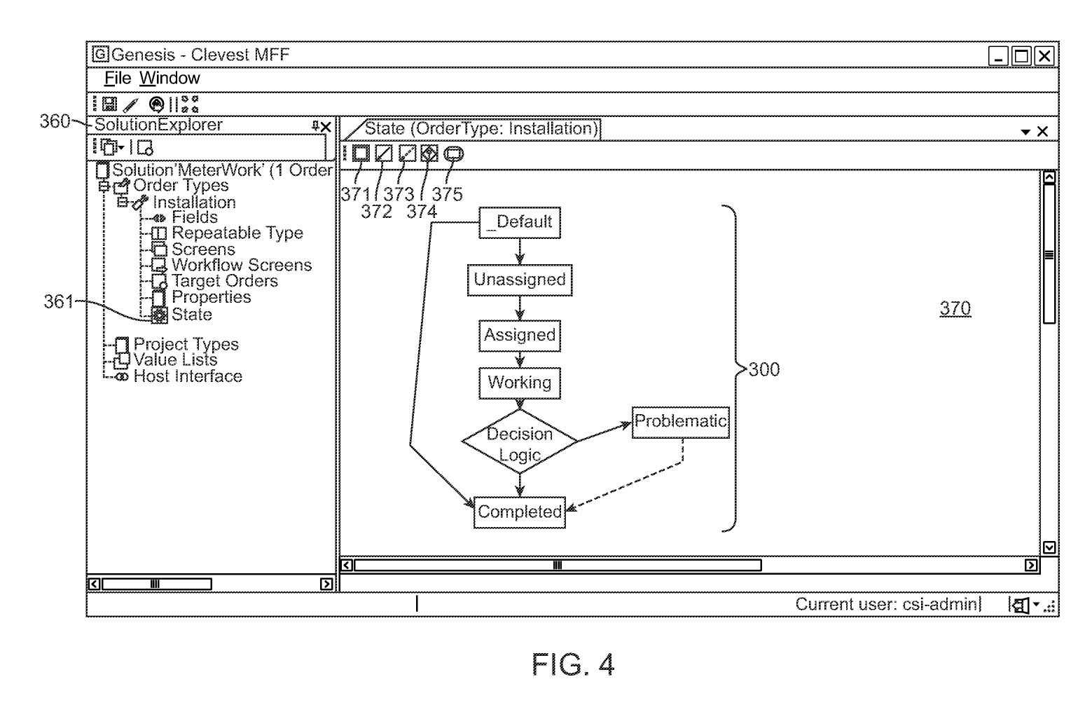

Referring to FIG. 4, new state flows may be created for each work order type by selecting the “State” option 361 from the GUI tool's function menu 360. The GUI tool displays a State Flow Editor 370 that provides a screen area with a menu of allowable options to construct and edit a state flow 300.

The user configures the state flow 300 by applying appropriate graphic options that are provided in a menu of available options to define the states and state transitions. The graphic options may include arrows, broken line arrows, and other predefined images to represent states 371, state transitions 372, temporal transitions 373, and decision logic 374. The user may apply the “select” 375 option and select each graphic element within a state flow presented within the State Flow Editor 370, including arrows, broken line arrows, and predefined images by using a pointing device or touch screen to open a screen allowing for further detailed configuration of the element represented by the selected graphic.

When the user selects a state graphic within the state flow the GUI tool displays a screen area with the Order State Editor 400 to enable the detailed configuration of the selected state.

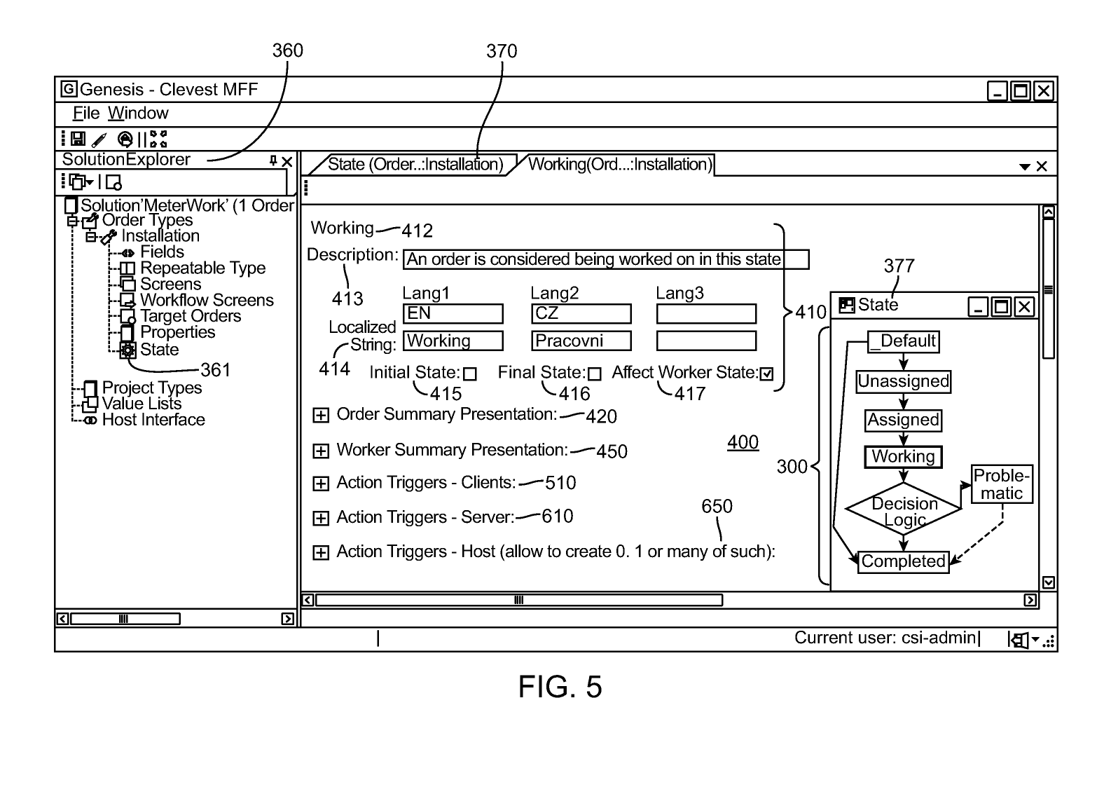

Referring to FIG. 5, the GUI configuration tool allows the user to maintain a view of the state flow 300 while using the Order State Editor to configure order states and order state properties. A view of the state flow 300 is displayed in a screen 377 that may be superimposed on the Order State Editor screen area 400. By providing the user with a simultaneous view of the state flow while creating and editing individual states, the user can maintain a visual perspective of the business process. The user may also remove the state flow display from view and bring the State Flow Editor 370 back into view by selecting the view options that are provided in the toolbar.

FIG. 5 shows the main components of the GUI configuration tool's Order State Editor 400. The Order State Editor 400 offers a plurality of configurable order state properties that are displayed through a plurality of sub-screens, including a Basic Attributes screen area 410, Order Summary Presentation sub-screen 420, Worker Summary Presentation sub-screen 450, Action Triggers Clients sub-screen 510, Action Triggers Server sub-screen 610, and Action Triggers Host sub-screen 650. Each of the sub-screens may be expanded in terms of presentable screen area to show all configurable options and details, and may also be reduced in terms of presentable screen area to only show the sub-screen title.

Referring to FIG. 5 the Basic Attributes screen area 410 allows a user to configure the name 412 of an order state, a description 413 of the order state, localized language strings 414 of the order state, and the option to set the order state as an “Initial State” 415 or a “Final State” 416 of a state flow, and to indicate if the current state affects worker states by selecting the “Affect Worker State” option 417.

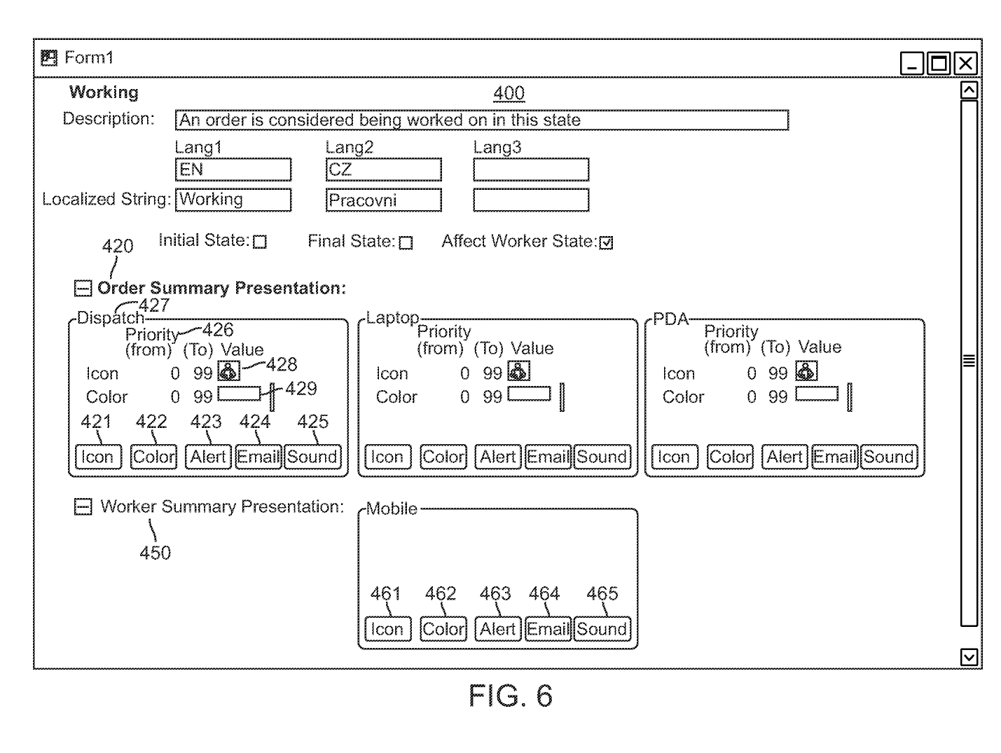

Referring to FIG. 6 the Order Summary Presentation sub-screen 420 allows a user to configure the means of representing the order state to the relevant participants of the business process, such as dispatchers, mobile workers and administrators. Users may select and configure the means of representing a particular order state with elements that include graphic icons 421, colors 422, alerts 423, email 424, and sound files 425. The user may select each of the elements with a pointing device, such as a mouse, to open a drop down menu that provides a plurality of options selectable by the user. The user may configure different representations of an order state for each type of worker 427 where multiple worker types are involved in a business process. Users may also configure different representations and notifications of work orders with various job priority levels 426 in a particular order state and independently configure the representation of each job priority level 426 for each worker type 427. The example shows the configuration of a specific graphic icon 428 and color 429 to represent work orders in the “Working” state that are assigned a priority number ranging from 0 to 99.

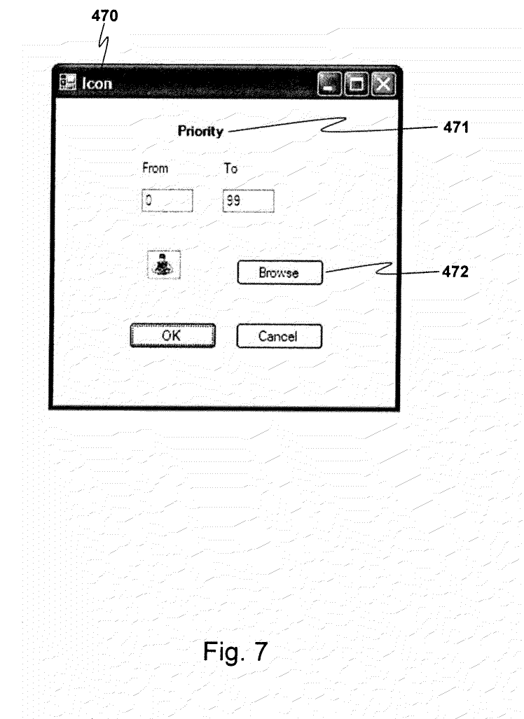

The Worker Summary Presentation sub-screen 450 enables users to configure the presentation of worker states in relation to a particular order state. The system employs a plurality of worker states to enable the system and dispatcher to identify states of worker activities, which assist the system and dispatcher in tracking and scheduling worker activities. A user may configure a plurality of elements to identify worker states including graphic icon 461, color 462, alert 463, email 464, and sound 465. FIG. 7 shows a screen area 470 that is displayed when the user chooses to configure the worker state graphic icon 461. The user may configure the use of a graphic icon by choosing the “Browse” option 472 and selecting an icon from a list of available options. A plurality of worker state representations may be independently configured for each work order priority level 471 where multiple work order priority levels are configured.

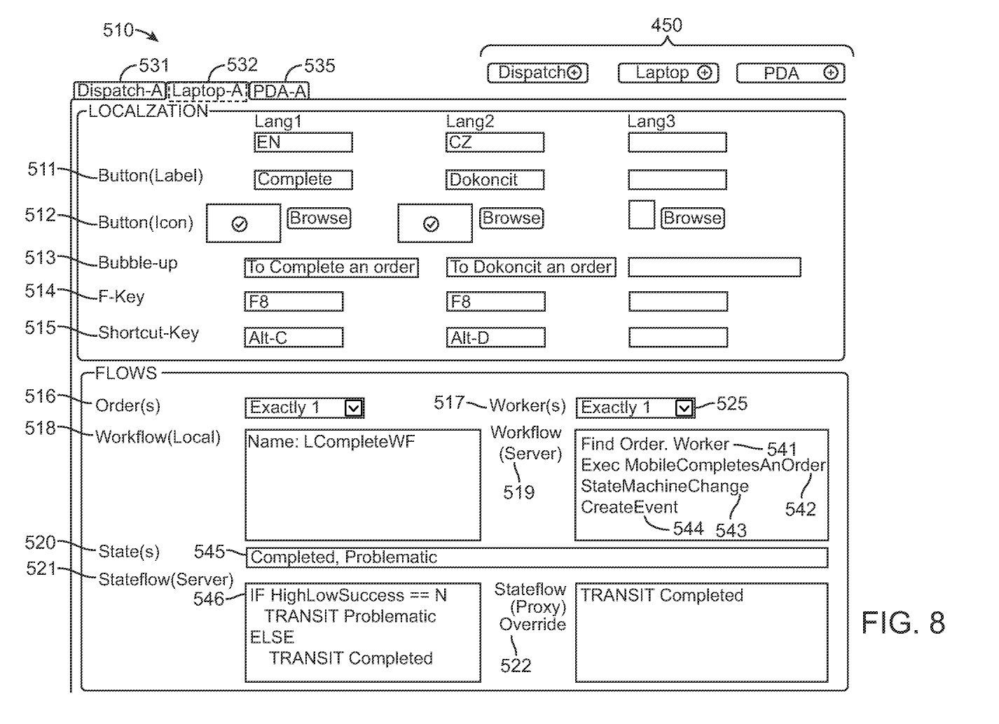

FIG. 8 shows the Action Triggers Clients sub-screen 510, which provides a menu of configurable elements that include Button Label 511, Button Icon 512, Bubble-up 513, F-Key 514, Shortcut-Key 515, Order(s) 516, Worker(s) 517, Workflow (Local) 518, Workflow (Server) 519, State(s) 520, State flow (Server) 521, State flow (Proxy) Override 522. Through the Action Triggers Clients sub-screen 510 the user may configure the buttons and shortcut-keys on client devices that trigger user defined actions performed on server 101 and/or on client devices. Client devices include mobile devices 130 such as cellular phones, smart phones, Personal Digital Assistants (PDAs), handheld computers, laptop computers, tablet computers, and desktop computers 115. The user may configure the buttons and shortcut-keys using the Button Label 511, Button Icon 512, and the Bubble-up 513, F-Key 514 and Shortcut-Key 515 elements, for a plurality of worker types. The button and shortcut-key configurations may be configured independently for each worker type amongst a plurality of worker types. Worker types may be defined and represented by their function or by the type of client device employed, including Dispatcher 531, Laptop 532, Personal Digital Assistant (PDA) 535, and devices such as a Blackberry™, and an iPhone™.

A user may configure the Button Label 511, Button Icon 512, and the Bubble-up 513, F-Key 514 and Shortcut-Key 515 elements for each type of client device and/or worker type by entering the appropriate descriptive text, and/or selecting the appropriate graphic icon from a drop down menu of available options. A plurality of descriptive text may be entered in different languages to provide a plurality of optional language strings for the Button Label 511, and Bubble-up 513 elements.

The Order(s) element 516 and the Worker(s) element 517 enable a user to define the allowable number of orders and workers that may be affected by the user defined actions triggered by client devices in a particular order state. A user may configure the Order(s) element 516 and the Worker(s) element 517 by selecting an option from a plurality of options that are available in a drop down menu of allowable parameters 525. The allowable parameters for configuring the Order(s) element 516 and the Worker(s) element 517 may include “None allowed”, “Exactly 1”, “1 or many”, and “0,1, or many”.

The Action Triggers Clients sub-screen 510 provides a Workflow (Local) 518 element that enables users to configure appropriate workflow actions that may be triggered by workers on client devices. Users may configure the appropriate workflow actions by assigning appropriate workflow files that may be executed on client devices when a worker selects the corresponding action trigger button or selects the corresponding shortcut-key on client devices. Workflow files include the definitions for the dispatcher screens, mobile device workflow screens, data fields, and workflow logic, that are executed on client devices to assist workers in performing the appropriate actions of a workflow. Workflow files may be assigned independently for each worker type.

The Workflow (Server) element 519 allows users to configure the appropriate workflow actions that will be executed on server 101 when a worker selects the corresponding action trigger button or selects the corresponding shortcut-key on a client device. Users may configure the appropriate workflow actions by assigning appropriate processes in the Workflow (Server) element 519. FIG. 8 shows the Workflow (Server) 519 actions for the “Working” state that include “Find Order, Worker” 541, “Execute MobileCompletesAnOrder” 542, “StateMachineChange” 543, which runs stateflow-server decision logic, and “CreateEvent” 544.

The State(s) element 520 shows a list of states 545 to which the current state may transition as defined by the state flow 300 in the State Flow Editor 370. In the example shown, the states include “Completed” and “Problematic”.

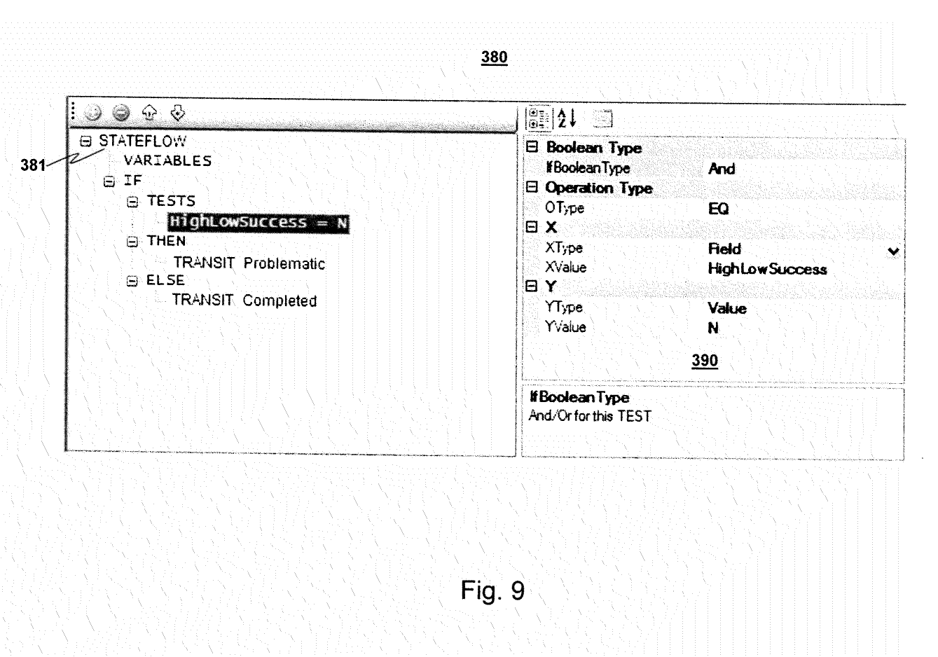

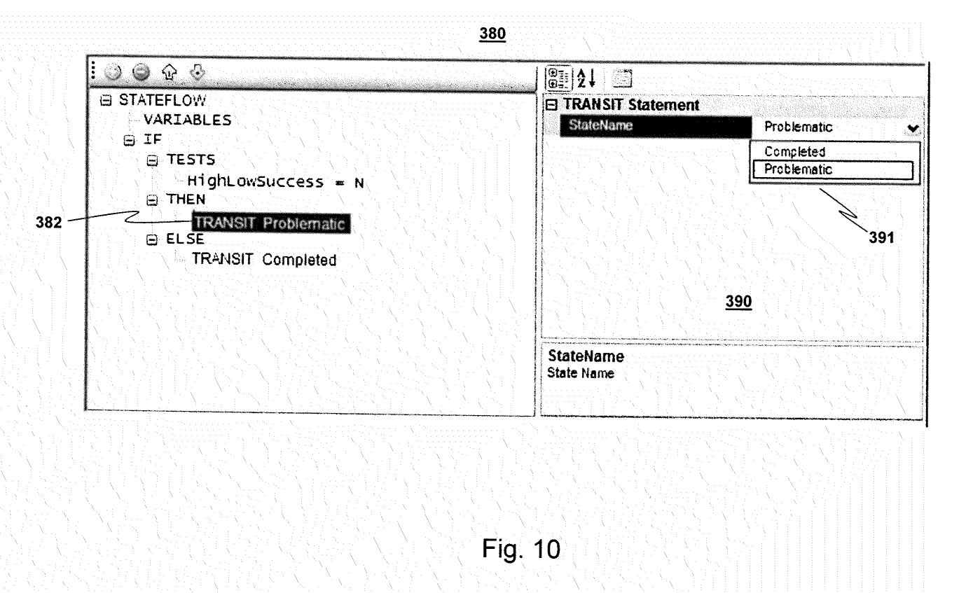

The State flow (server) element 521 allows the user to configure the decision logic that is executed by server 101 to determine the appropriate subsequent state transition. A user may configure the decision logic by selecting the State Flow (server) element 521 to open the State Flow Logic Editor 380, or by selecting a state transition arrow 372 or decision logic graphic 374 of a state flow within the State Flow Editor 370. Referring to FIG. 9 the State Flow Logic Editor 380 provides a context sensitive menu 390 of allowable functions, parameters, data fields, and repeatable data fields in user friendly spoken language syntax for configuring the state flow logic statements. Repeatable data fields, also referred to herein as “repeatables”, are fields that are a combination of fields that tend to repeat many rows and are also known as tables in HTML paradigm. The state flow logic 381 may perform decision logic including tests, validation rules, “If-Then-Else” functions and “While” loops. The state flow logic may be configured to transition from state to state by employing a “Transit” command 382. Referring to FIG. 10, the State Flow Logic Editor's 380 context sensitive menu 390 displays a list of available states 391 according to state flow 300 for configuring subsequent state transitions when the user selects the “Transit” command 382.

Referring to FIG. 8, the State flow (Proxy) Override 522 allows users to configure a subsequent state transition that is triggered by client devices, which overrides the state transition as defined by the state flow logic. In the example shown, the State flow (Proxy) Override 522 is configured to transit to the “Completed” state. Users may leave fields blank when any particular element is not applicable to an order state or to a worker type.

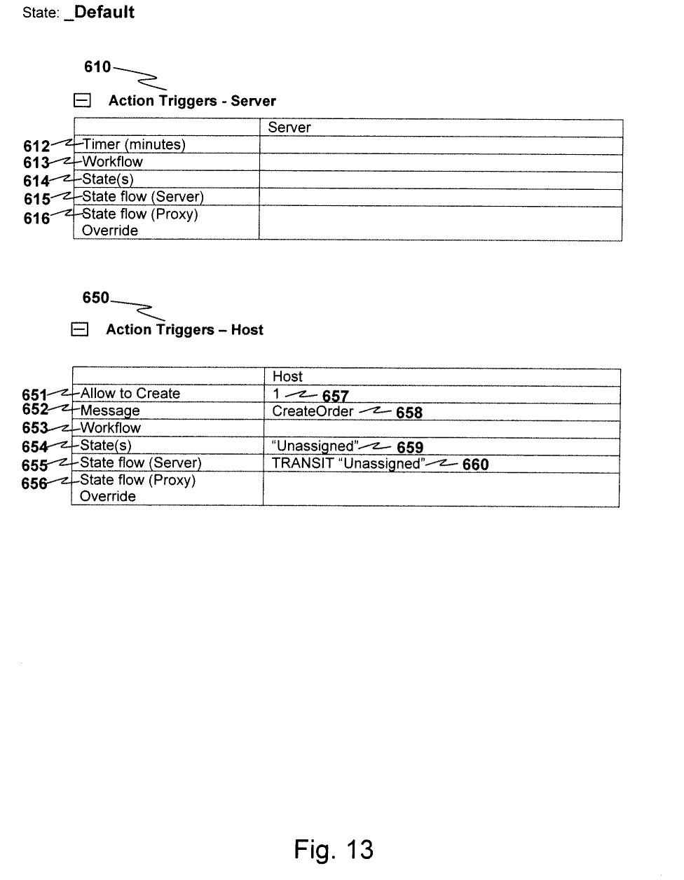

The Action Triggers Server sub-screen 610 allows users to configure actions that are executed by server 101 when triggered by a temporal trigger. FIG. 13 shows a list of elements that may be configured through the Action Triggers Server sub-screen 610. The Time element 612 allows users to configure the temporal trigger in terms of minutes after which server 101 executes the user defined actions. The Workflow element 613 allows users to select the workflow files that are to be executed by the server. The State(s) element 614 defines the states to which the work order may transition. The State flow (server) element 615 allows the user to configure the decision logic that will determine the appropriate subsequent state transition. The State flow (Proxy) Override 616 allows users to configure a subsequent state transition that may override the state transition as defined by the state flow logic.

The Action Triggers Host sub-screen 650 allows users to configure actions that are executed by server 101 when triggered by host 1 16. FIG. 13 illustrates the elements that are configurable through the Action Triggers Host sub-screen 650. The Allow to Create element 651 allows users to configure the allowable number of work orders 657 that are created when the host triggers the creation of work orders. The Allow to Create element 651 is configured by selecting a parapeter 657 of 0, 1, or many from a drop down menu that is made available to the user when the Allow to Create element 651 is selected with a pointing device. The Message element 652 allows users to configure a message such as “CreateOrder” 658 that may be displayed on a client device. The Workflow element 653 allows users to select the workflow files that are to be executed by server 101. The State(s) element 654, allows users to define the allowable states to which the work order may transition. In the example shown, the allowable state to which the work order may transition is defined as “Unassigned” 659 representing the “Unassigned” state 3 10. The State flow (server) element 655 allows the user to configure the decision logic that determines the appropriate subsequent state transition. The state flow logic is configured with Transit “Unassigned” 660 to transition the work order to the “Unassigned” state 310. The State flow (Proxy) Override 656 allows users to configure decision logic that may override the state flow logic.

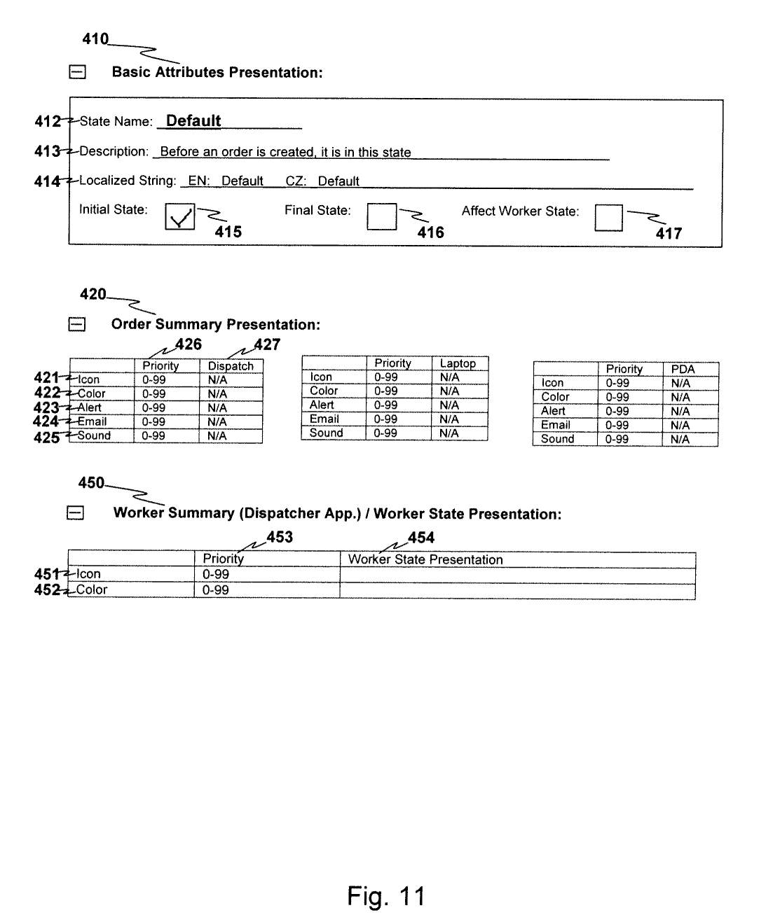

FIG. 11 through FIG. 22 illustrate the configuration of the order states that are defined by the state flow 300 shown in FIG. 3.

FIG. 11 illustrates the configuration of the “_Default” order state 305 that may be implemented through the GUI configuration tool's Order State Editor 400. The Basic Attributes sub-screen 410 shows the entry of the state name as “_Default” 412. A description 413 for the order state is entered as, “Before an order is created, it is in this state”. The name “_Default” is entered in English and in Czechoslovakian in the Localized String element 414. The Localized String element 414 enables a user to create a plurality of optional names in multiple languages including, in the example shown, English and Czechoslovakian, which may be selected to represent the order state within the system according to the preferred language of workers in a particular locality. The order state is configured as an “Initial State” 415. The “Initial State” 415 distinguishes the order state as the first state of the state flow 300. An initial state 415 represents a state where a particular event triggers the system to execute particular actions and create a work order. The Order Summary Presentation 420 and the Worker Summary Presentation 450 sub-screens are displayed in grey to indicate that they are made unavailable to the user for configuration, as an “Initial State” does not require the involvement of workers.

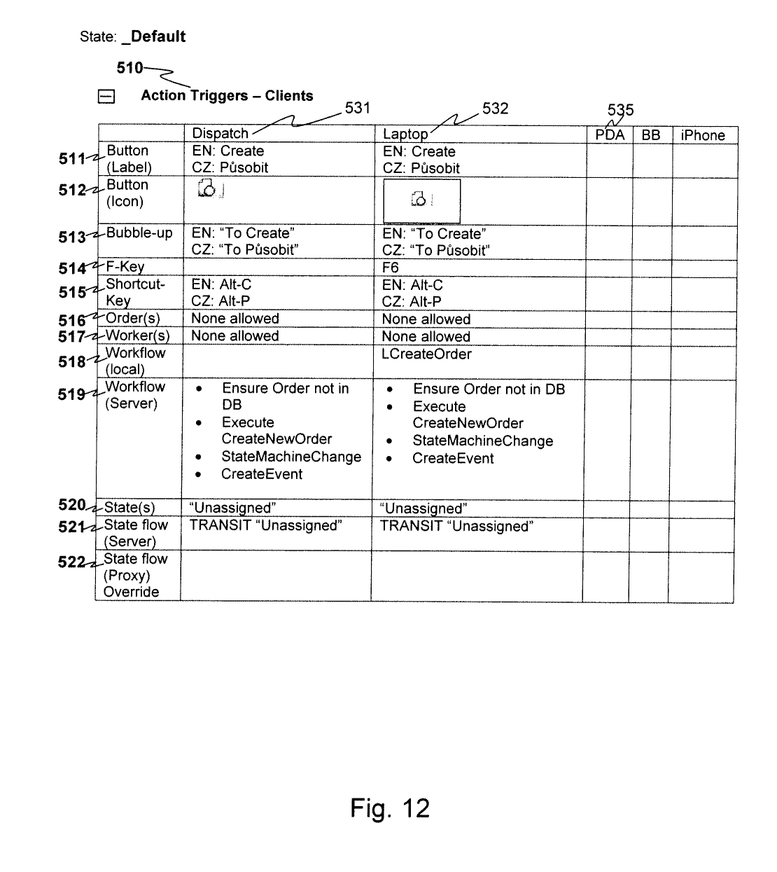

FIG. 12 illustrates the Action Triggers Clients sub-screen 510 of the “Default” order state 305. The Button (label) 511, Button (Icon) 512, Bubble-up 513, F-Key 514 and Shortcut-key 515 elements are configured with the appropriate text and graphic icons to represent and trigger the “To Create” function. The Button (label) 511 configurations are displayed in grey to indicate that the button label properties have been made unavailable to the user for configuration.

The Order(s) element 516 and the Worker(s) element 517 are configured with the parameter “None allowed”.

The Workflow (local) element 518 is configured with a workflow file named “LCreateOrder” that is executed on a client device when the defined action trigger Button (Icon) 512, F-Key 514 or defined Shortcut-Key 515 is selected on the Laptop device 532. The user may double click on the “LCreateOrder” file name with a pointing device to select an alternative file from a drop down menu of available workflow files.

The Workflow (Server) 519 option shows the server actions that are executed including “Ensure Order not in database”, “Execute CreateNewOrder”, “StateMachineChange”, which runs stateflow-server decision logic, and “CreateEvent”.

The State(s) element 520 shows that the subsequent state transition is the “Unassigned” state 545. The State(s) element 520 is displayed in grey to indicate that it is unavailable for configuration as all new work orders are predefined to transition from the initial “_Default” state 305 to an “Unassigned” state 310.

The State flow (server) element 521 shows that the state flow logic has been configured to transition to the “Unassigned” state.

FIG. 13 illustrates the configuration for the Action Triggers Server sub-screen 610 for the “_Default” state 305, which is displayed in grey to indicate that it is unavailable for configuration. The Action Triggers Host sub-screen 650 is configured to display a “CreateOrder” message and to transition the “_Default” state 305 to the “Unassigned” state 310.

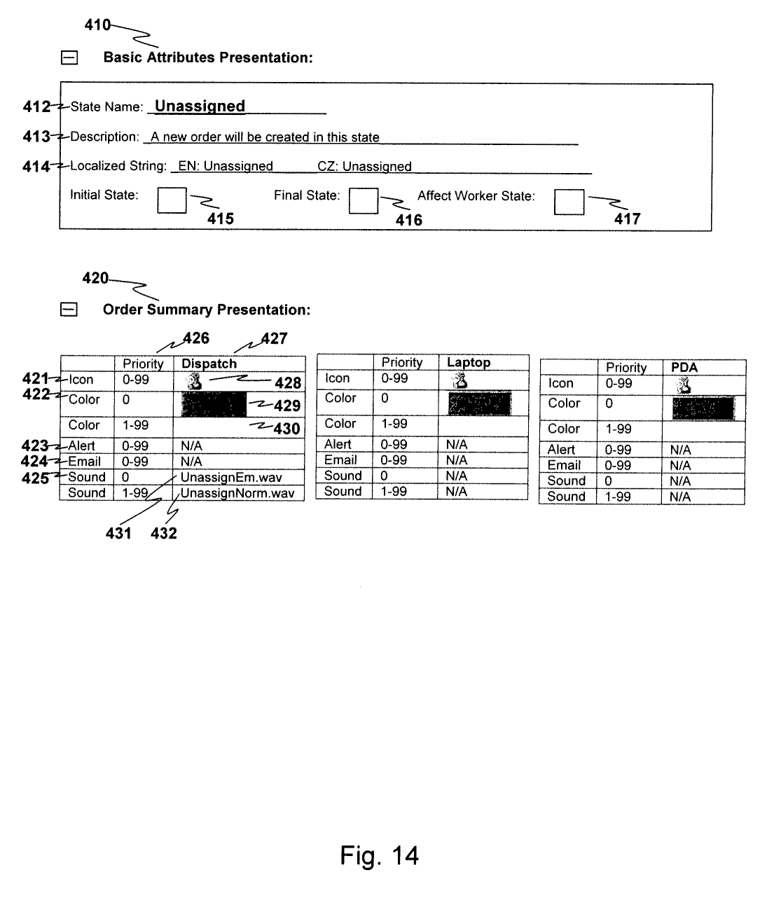

FIG. 14 shows the configuration for the Basic Attributes sub-screen 410 and Order Summary Presentation sub-screen 420 for the “Unassigned” state 310. The Basic Attributes sub-screen 410 shows the entry of the state name 412 as “Unassigned”. A description 413 for the order state is entered as, “A new order will be created in this state”. The name “Unassigned” is entered in English and in Czechoslovakian in the Localized String element 414.

Through the Order Summary Presentation sub-screen 420 “Unassigned” work orders may be appointed a priority number 426 ranging from 0 to 99. FIG. 14 shows that “Unassigned” work orders with priority numbers ranging from 0 to 99 are represented with a specified graphic icon 428. Graphic icons may be configured by selecting an icon from a dropdown menu of available icons that is made available when a user selects the icon element 421 with a pointing device. Work orders may also be displayed with specific colors 422 on client devices. “Unassigned” work orders that are appointed the priority number 0 are represented in red 429 and employ an “UnassignEm.wav” sound file 431 to notify dispatchers. “Unassigned” work orders with priority numbers ranging from 1 to 99 are represented in yellow 430 and employ an “UnassignNorm.wav” sound file 432 to notify dispatchers. Alerts and emails may also be configured to notify dispatchers and workers of particular work orders.

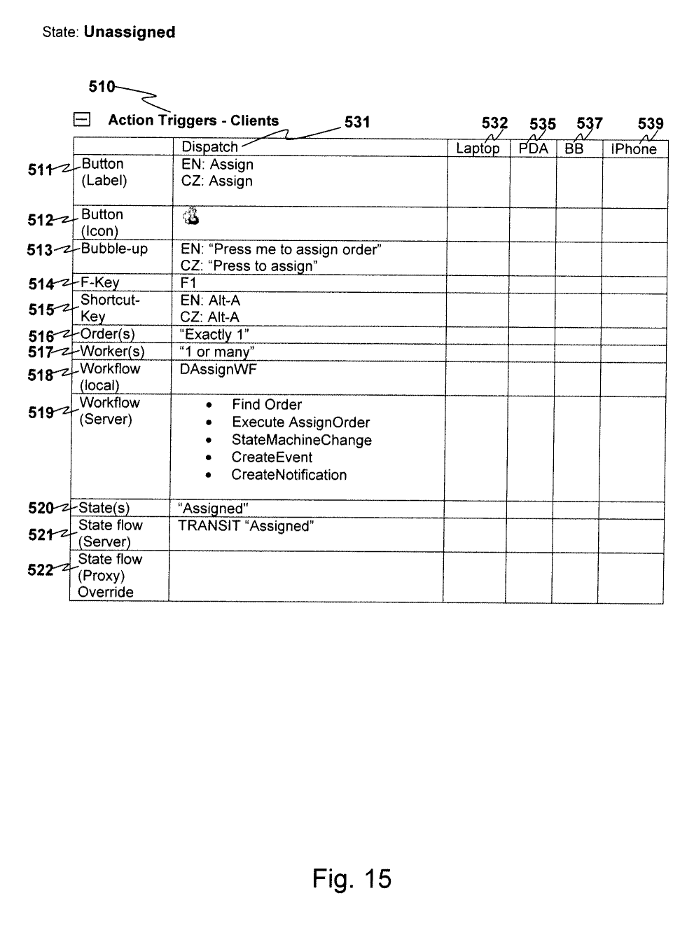

FIG. 15 shows the Action Triggers Client sub-screen 510 for the “Unassigned” state 310. The Button (label) 511, Button (Icon) 512, Bubble-up 513, F-Key 514 and Shortcut-key 515 elements are configured with the appropriate text and graphic icons to represent and trigger the “Assign” functions for the Dispatch worker type 531

The Order(s) element 516 is configured with the parameter “Exactly 1” and the Worker(s) element 517 is configured with the parameter “1 or many”.

The Workflow (local) element 518 is assigned with the “DAssignWF” workflow file, which is executed on the Dispatch workstation when the defined action trigger Button (Icon) 512, F-Key 514 or defined Shortcut-Key 515 is selected on the Dispatch client 531. The user may double click on the “DAssignWF” file name with a pointing device to select an alternative file from a drop down menu of available workflow files.

The Workflow (Server) element 519 shows the actions that are executed by the server when the dispatcher selects either the Button, F-Key, or Shortcut-Key action triggers. The server is configured to execute workflow files that include “Find Order”, “Execute AssignOrder”, “StateMachineChange”, “CreateEvent”, and “CreateNotification”.

The State(s) element 520 shows that the subsequent state transition is the “Assigned” state 320. The State(s) element 520 is displayed in grey to indicate that it is unavailable for configuration as all “Unassigned” work orders are defined to transition from the “Unassigned” state 310 to the “Assigned” state 320 in accordance to state flow 300.

The State flow (server) element 521 shows that the subsequent transition state is the “Assigned” state 320. The user may double click on the “Assigned” state to open the State Flow Editor to edit the state flow logic.

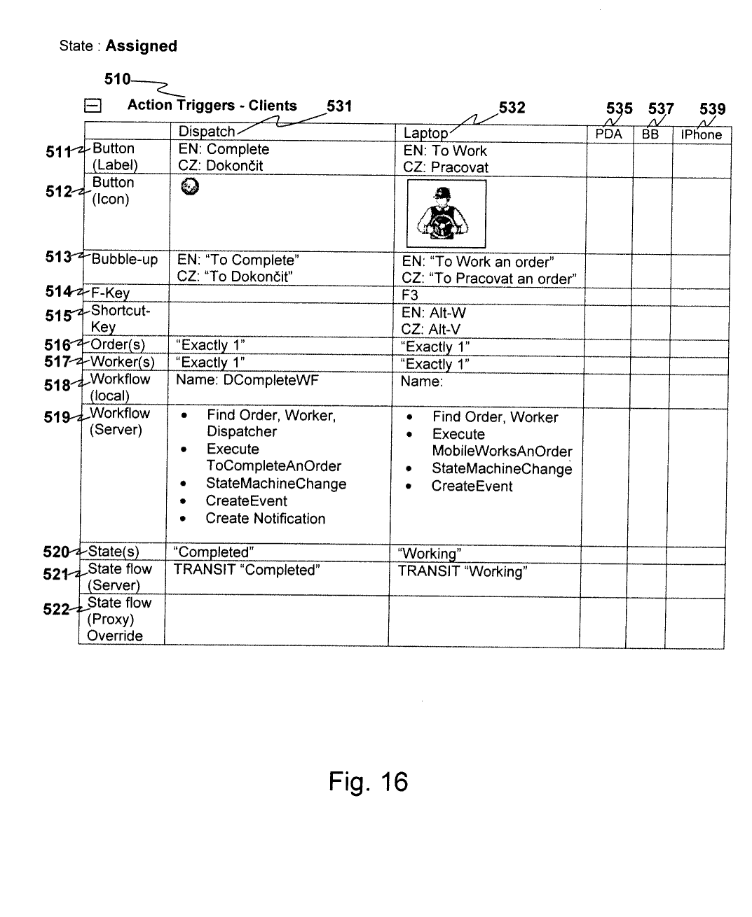

FIG. 16 shows the Action Triggers Clients sub-screen 510 for the “Assigned” state 320. The “Assigned” state 320 involves two worker types including “Dispatch” 531 and “Laptop” 532. Each element within the Action Triggers Clients sub-screen 510 may be configured differently for each worker type. The Dispatch worker type 531 may trigger the work order to transition to the “Completed” state 350. The Button (label) 511, Button (Icon) 512, Bubble-up 513 elements are configured with the appropriate text and graphic icons to represent and trigger the “To Complete” functions for the Dispatch worker type 531. The Laptop worker type 532 may trigger the work order to transition to the “Working” state 330. The Button (label) 511, Button (Icon) 512, Bubble-up 513, F-Key 514 and Shortcut-key 515 elements are configured to represent and trigger the “To Work” functions for the Laptop worker type 532.

The Order(s) element 516 and the Worker(s) element 517 are configured with the parameter of “Exactly 1” for the Dispatch worker type 531 and the Laptop worker type 532.

The Workflow (local) element 518 is assigned with the workflow file “DCompleteWF”, which is executed on the Dispatch client 531 when the defined action trigger Button (Icon) 512 is selected on the Dispatch client 531. The user may double click on the “DCompleteWF” file name with a pointing device to select an alternative file from a drop down menu of available workflow files. Workflow files are not assigned for Laptop clients 532.

The Workflow (Server) element 519 shows the configured server actions that are executed when a Dispatch worker 531 or a Laptop worker 532 triggers the “To Complete” functions or the “To Work an order” functions respectively. When a Dispatch worker 531 triggers the “To Complete” functions the server is configured to execute processes that include “Find Order, Worker, Dispatcher”, “Execute ToCompleteAnOrder”, “StateMachineChange”, “CreateEvent”, and “CreateNotification”. When a Laptop worker 532 triggers the “To Work” functions the server is configured to execute workflow files that include “Find Order, Worker”, “Execute MobileWorksAnOrder”, “StateMachineChange”, and “CreateEvent”.

The State flow (server) element 521 shows the configuration of the subsequent transition states for the Dispatch worker type 531 and the Laptop worker type 532. When the Dispatch worker 531 triggers the “To Complete” functions the current state transitions to the “Completed” state 350. The user may double click on the “Completed” state in the State flow (server) element 521 to open the State Flow Editor to edit the state flow logic. When the Laptop worker 532 triggers the “To Work” functions the current state transitions to the “Working” state 330. The user may double click on the “Working” state in the State flow (Server) element 521 to open the State Flow Editor to edit the state flow logic.

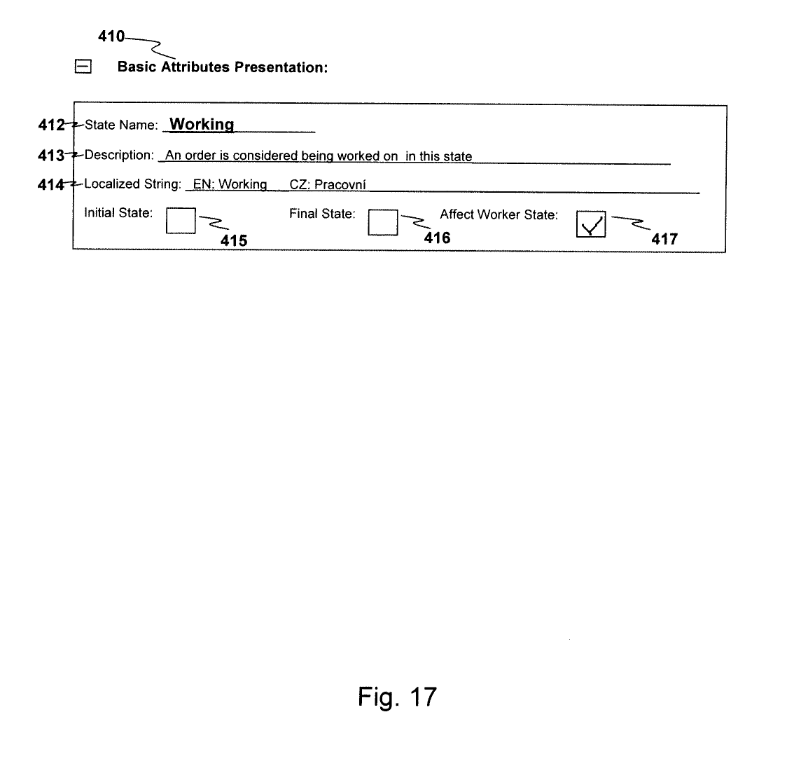

FIG. 17 illustrates the Basic Attributes sub-screen 410 for the “Working” state 330. The Basic Attributes sub-screen 410 shows the entry of the state name 412 as “Working”. A description 413 for the order state is entered as, “An order is considered being worked on in this state”. The name “Working” is entered in English and “Pracovni” is entered in Czechoslovakian in the Localized String element 414. The “Affects Worker State” 417 element is marked to indicate that work orders in the “Working” state 330 are configured to affect the “worker state” of individuals who are involved in the processing of such work orders. “Worker states” are used by the system and/or dispatchers to identify, track and manage workers by indicating the state of a worker from a plurality of states that may include “Signed-on”, “Signed-off”, “Enroute”, “Onsite” and “Working”. The selection of “Affects worker state” 417 in the Basic Attributes sub-screen 410 of FIG. 10 affects worker states by transitioning worker states to “Working” when a worker begins to process a work order and triggers the work order to transition to the “Working” state 330.

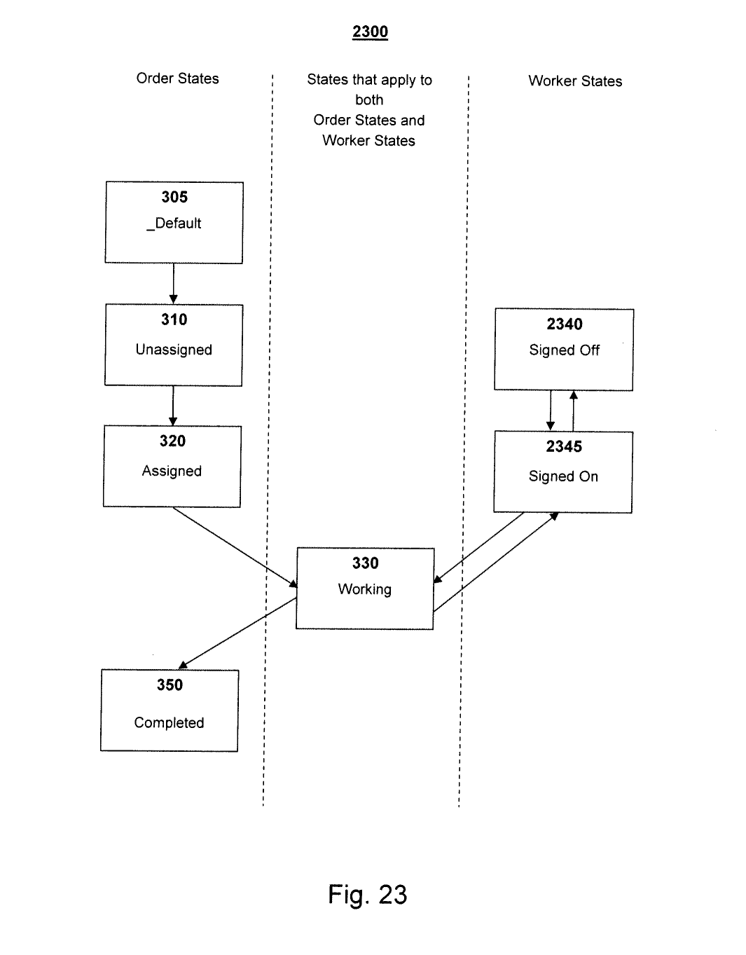

FIG. 23 illustrates the state flow of order states and worker states during the processing of an exemplary work order. Order states include “Default” state 305, “Unassigned” state 310, “Assigned” state 320, “Working” state 330, and “Complete” state 350. Worker states include “Signed Off” state 2340, “Signed On” state 2345, and “Working” state 330. FIG. 23 shows that particular states such as the “Working” state 330 may apply to an order state and also affect and apply to, a worker state.

In another embodiment of the invention, a screen area with a Worker State Logic Editor (not shown) may be provided for users to create and modify worker states and worker state decision logic to govern the transition of worker states. The Worker State Logic Editor may provide a context sensitive menu of allowable functions, parameters, data fields, and repeatable data fields in user friendly spoken language syntax for configuring the worker state decision logic statements. The worker state decision logic may perform decision logic including tests, validation rules, “If-Then-Else” functions and “While” loops. A Worker State Editor may also be provided to enable a user to configure a plurality of worker state properties including action triggers, and presentation elements such as graphic icons, colors, alerts, email notifications, and sound files that are used to identify worker states.

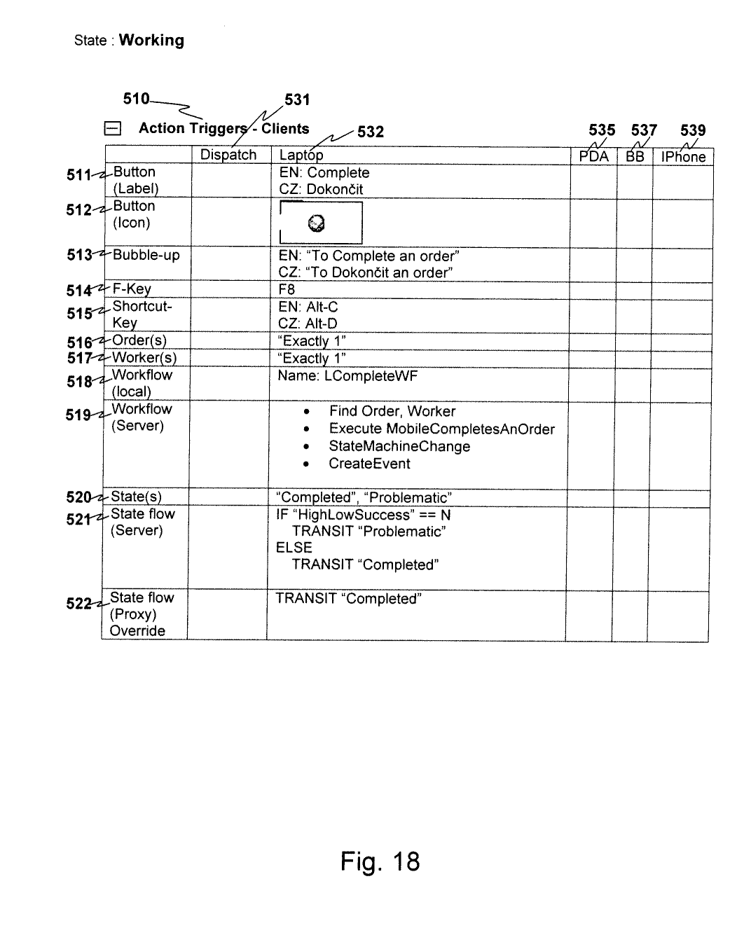

FIG. 18 shows the Action Triggers Clients sub-screen 510 for the “Working” state. The Button (label) 511, Button (Icon) 512, Bubble-up 513, F-Key 514 and Shortcut-key 515 elements are configured with the appropriate text and graphic icons to represent and trigger the “Complete” functions for the Laptop worker type 532.

The Order(s) element 516 and the Worker(s) element 517 are configured with the parameter of “Exactly 1”.

The Workflow (local) element 518 is assigned with the workflow file “LCompleteWF” which is executed on the laptop when the defined action trigger Button (Icon) 512, F-Key 514 or defined Shortcut-Key 515 is selected on the laptop 533. The user may use a pointing device to double click on the “LCompleteWF” file name in the Workflow (local) element 518 to select an alternative file from a list of available workflow files.

The Workflow (Server) element 519 shows the server actions that are to be executed when the Laptop worker 532 triggers the “Complete” function, which includes “Find Order, Worker”, “Execute MobileCompletesAnOrder”, “StateMachineChange”, and “CreateEvent”.

The State flow (server) element 521 shows the decision logic that is executed to determine if the work order should subsequently transition to the “Problematic” state 340 or the “Completed” state 350. The user may double click on the logic statements to open the State Flow Editor to edit the state flow logic.

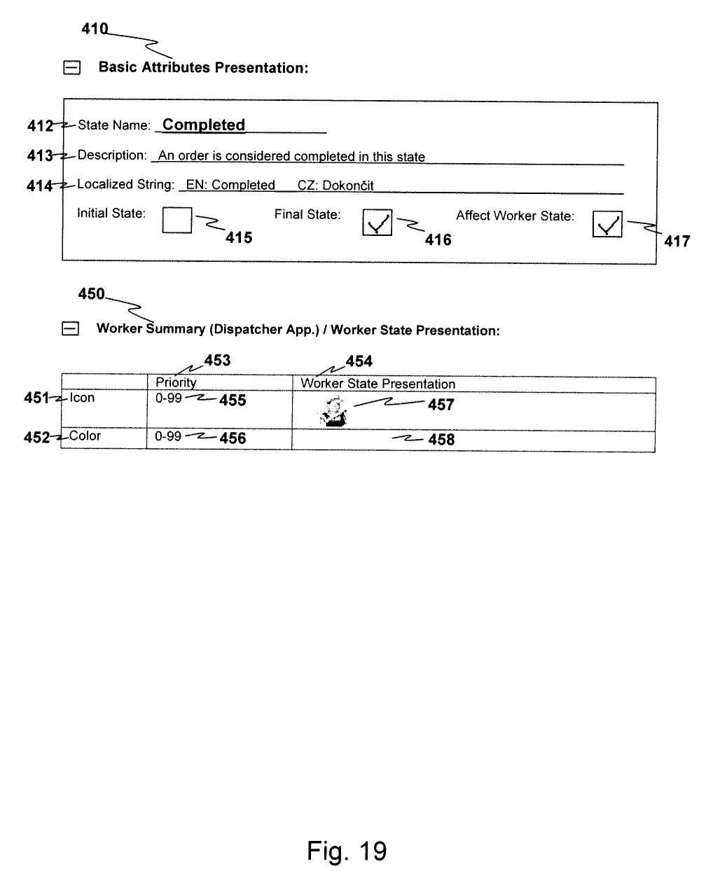

FIG. 19 illustrates the Basic Attributes sub-screen 410 and the Worker Summary Presentation sub-screen 450 for the “Completed” state 350. The Basic Attributes sub-screen 410 shows the entry of the state name 412 as “Completed”. A description 413 for the order state is entered as, “An order is considered completed in this state”. The name “Completed” is entered in English and the name “Dokoncit” is entered Czechoslovakian in the Localized String element 414. The “Completed” state 350 is configured as a “Final state” 416 of the state flow 300 and is also configured with “Affects Worker State” 417. The Worker Summary Presentation sub-screen 450 is configured to employ a specific graphic icon to represent the worker's “Available” state 457 when a work order with a priority number 455 ranging from 0 to 99 transitions to the “Completed” state 350. Worker states are represented with a blue color 458 when a worker order with a priority number 456 ranging from 0 to 99 transitions to the “Completed” state 350.

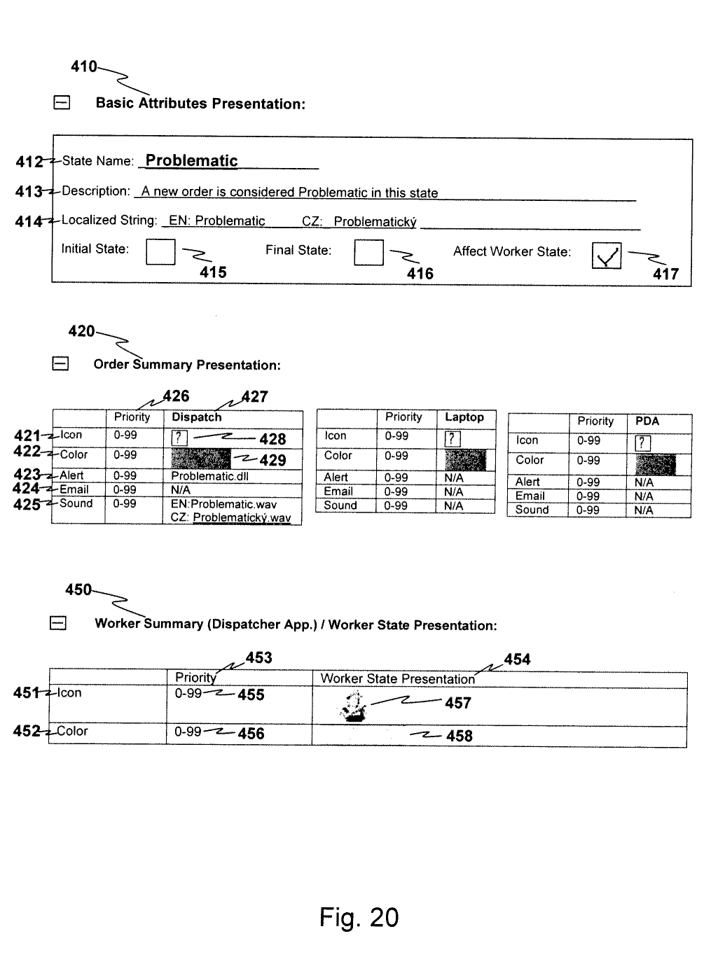

FIG. 20 illustrates the Basic Attributes sub-screen 410, the Order Summary Presentation sub-screen 420, and the Worker Summary Presentation sub-screen 450, for the “Problematic” state 340. The Basic Attributes sub-screen 410 shows the entry of the state name 412 as “Problematic”. A description 413 for the order state is entered as, “An order is considered Problematic in this state”. The name “Problematic” is entered in English and the name “Problematicky” is entered Czechoslovakian in the Localized String element 414. The “Problematic” state 340 is configured with “Affects Worker State” 417. The work order's “Problematic” state 340 in the Order Summary Presentation sub-screen 420 is distinguished by employing a red display colour 429 and a specified graphic icon 428. The Worker Summary Presentation sub-screen 450 is configured to employ a specific graphic icon 457 to represent the worker's state when a work order with a priority number 455 ranging from 0 to 99 transitions to the “Problematic” state 350. Worker states are represented with a blue color 458 when a work order, with a priority number 456 ranging from 1 to 99, transitions to the “Problematic” state 350.

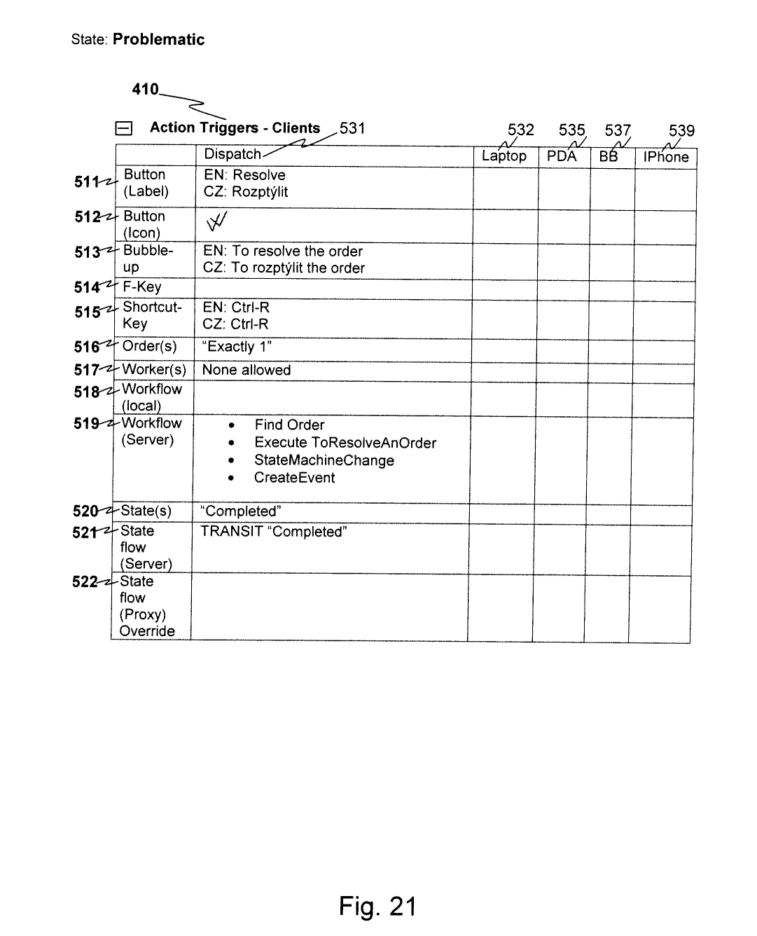

FIG. 21 illustrates the Action Triggers Clients sub-screen 410 for the “Problematic” state 340. The Button (label) 511, Button (Icon) 512, Bubble-up 513, F-Key 514 and Shortcut-key 515 elements are configured with the appropriate text and graphic icons to represent and trigger the “Resolve” functions for the Dispatch worker type 531.

The Order(s) element 516 is configured with the parameter “Exactly 1” and the Worker(s) element 517 is configured with the parameter “None allowed”.

The Workflow (Server) element 519 shows the server 101 actions that are to be executed when the dispatcher triggers the “Resolve” function, which include “Find Order”, “Execute ToResolveAnOrder”, “StateMachineChange”, and “CreateEvent”.

The State flow (server) element 521 shows that the subsequent transition state is the “Completed” state. The user may double click on the “Completed” state to open the State Flow Editor to edit the state flow logic.

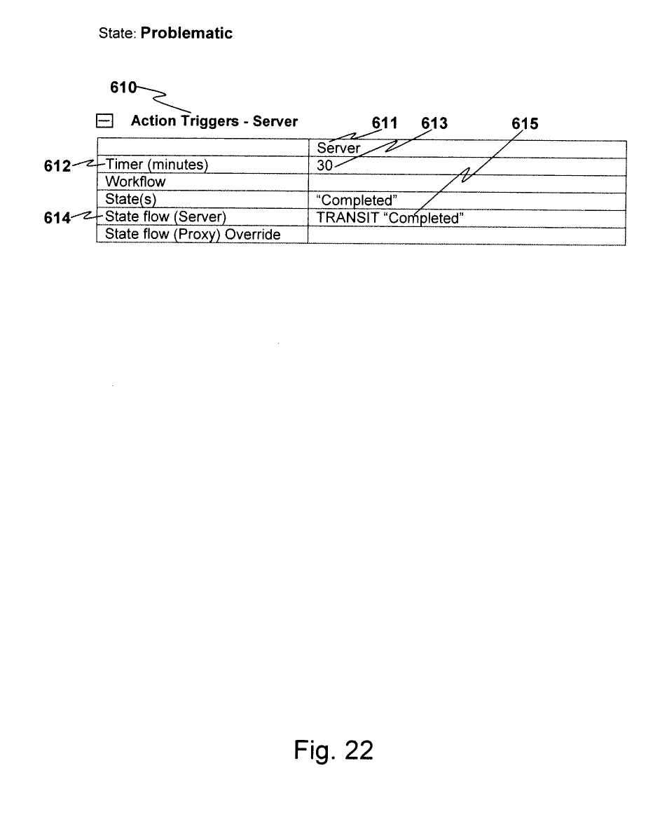

FIG. 22 illustrates the Action Triggers Server sub-screen 610 for the “Problematic” state 340, which shows the configurable actions that are executed by the server 611 based on a temporal trigger 345. The Timer element 612 is configured to count 30 minutes 613 from the initiation of the current state, after which the server will execute the actions that are defined in the State flow (server) element 614. The State flow (server) element 614 is configured for server 101 to transition the work order to the “Completed” state 615.

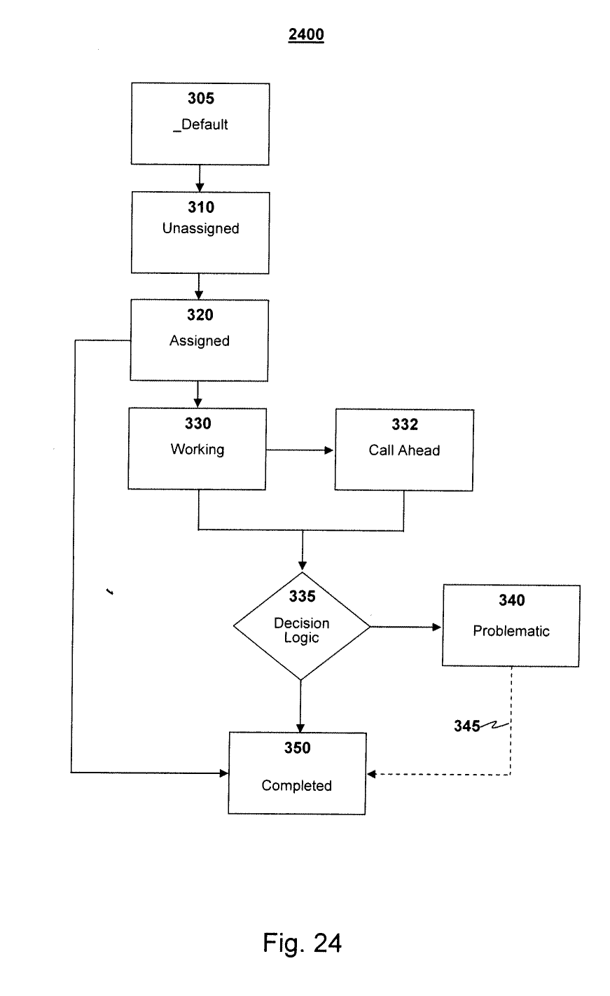

The GUI configuration tool enables users to modify state flows to accommodate any changes that are required in a business entity's processing procedures and methods. Changes to a business entity's processing methods and procedures may require the addition or deletion of particular states in a state flow. FIG. 24 illustrates a state flow 2400 that is modified from state flow 300 in FIG. 3 to include an additional “CallAhead” state 332. Newly generated work orders are defined with a “_Default” state 305 when they are initiated within the workflow management system. New “_Default” work orders then transition to an “Unassigned” order state 310. A dispatcher working with the system may then assign the “Unassigned” work orders to suitable employees. Work orders that have been assigned to workers will transition to an “Assigned” order state 320. Dispatchers may also reassign “Assigned” work orders to a “Completed” state 350. “Assigned” work orders that are being processed transition to a “Working” state 330. During the “Working” state a worker may execute a “CallAhead” function which causes the work order to transition to a “CallAhead” state 332. After the actions defined by the “CallAhead” state 332 are executed the system performs decision logic 335 to determine if the work order has been correctly processed and to transition the work order to a “Completed” state or whether omissions and errors are identified in which case the work order then transitions to a “Problematic” state 340. The system is configured with temporal trigger that transitions “Problematic” work orders 340 to the “Completed” state 350 after 30 minutes.

A user may use the State Flow Editor 370 to add a state within a particular point of an existing state flow. Where a new state must be created, the user selects the “state” option 371 to add a new state to the state flow in the State Flow Editor 370. The user may then double click the newly added state graphic in the state flow to configure the order state properties through the Order State Editor 400. The user may configure the appropriate elements in the Basic Attributes 410, Order Summary Presentation 420, Worker Summary Presentation 450, Action Trigger Clients 510, Action Trigger Server 610, and Action Triggers Host 650 sub-screens for the new order state. The user then saves the newly created state and exits the Order State Editor 400 to return to the State Flow Editor 370.

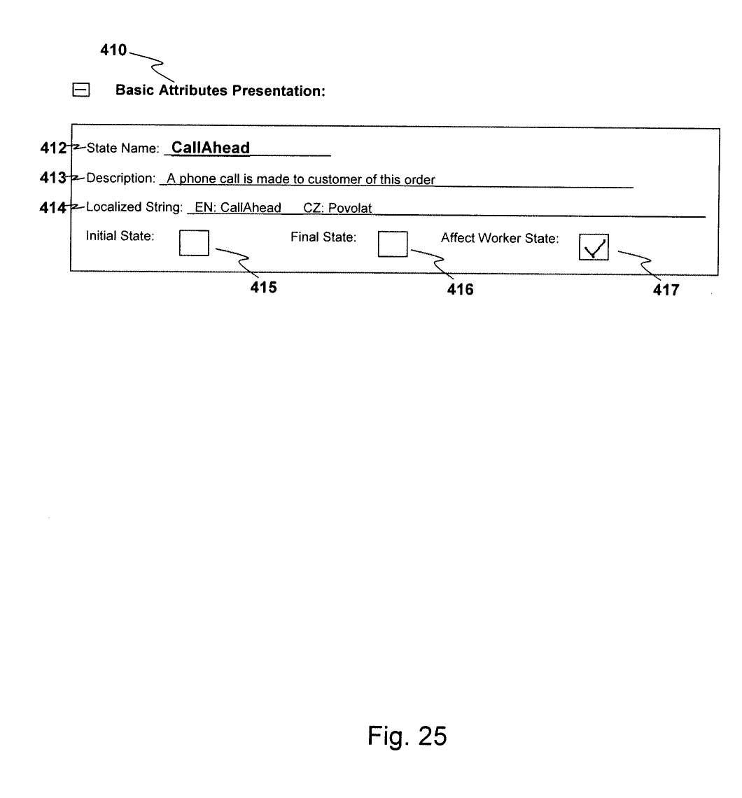

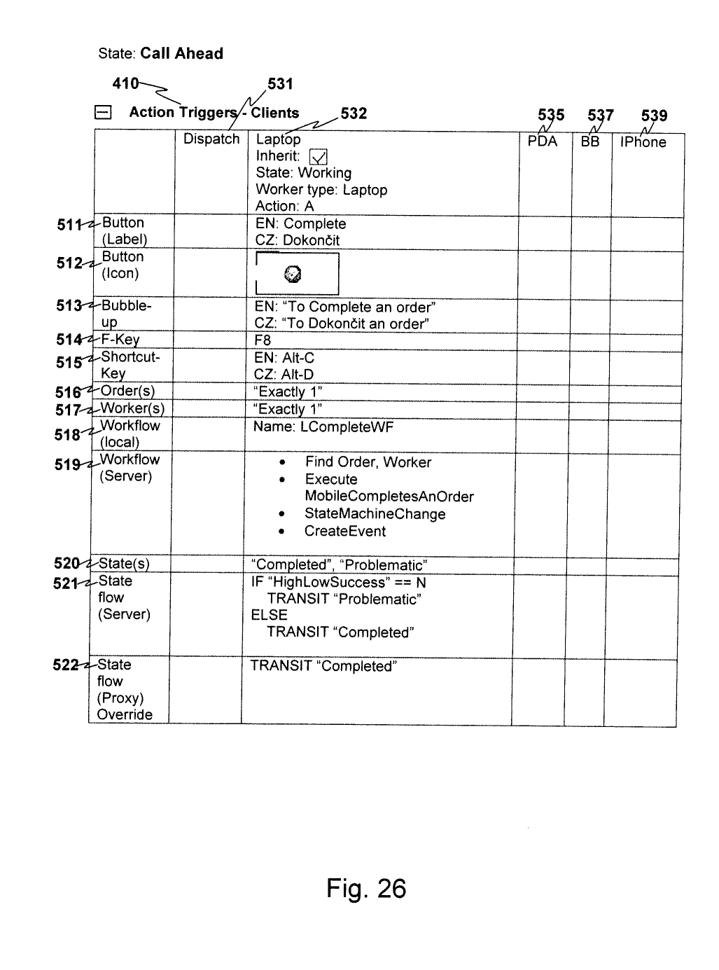

FIG. 25 and FIG. 26 illustrate the order state properties that may be configured for the “CallAhead” state 332. FIG. 25 shows the properties that may be configured through the Basic Attributes sub-screen 410 for the “CallAhead” state 332, in which the user defines the state name 412 as “CallAhead” and enters as description 413, “A phone call is made to customer of this order”. The name “CallAhead” is entered in English and the name “Povolat” is entered Czechoslovakian in the Localized String element 414. The “Call Ahead” state is configured with “Affect Worker State” 417.

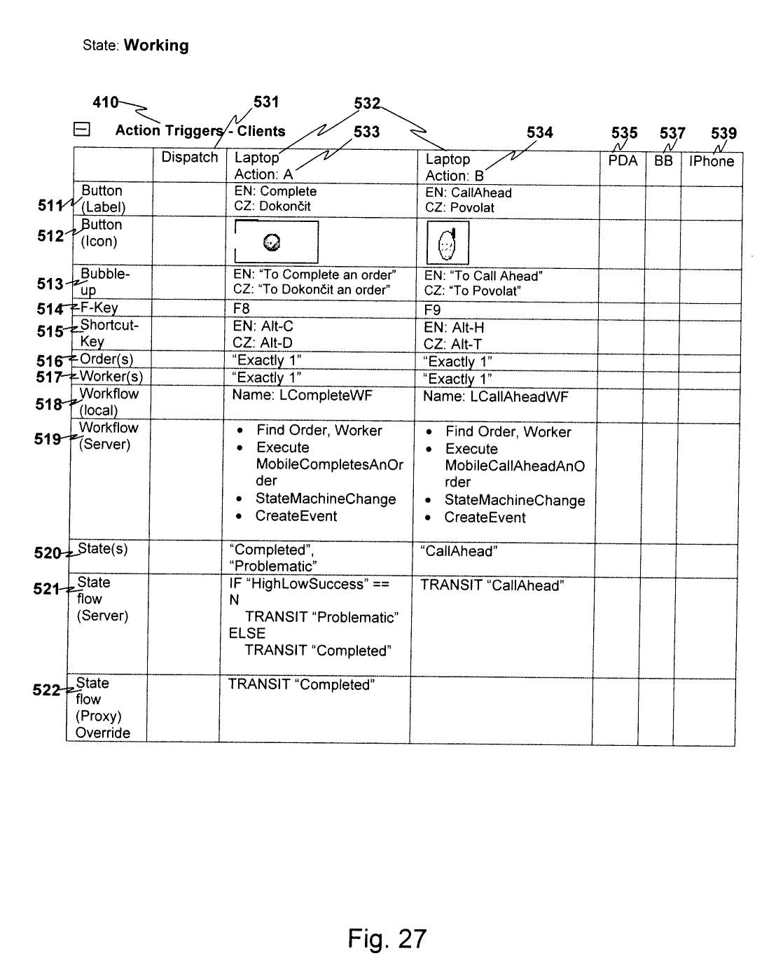

Referring to FIG. 26, the properties for the Action Triggers Client sub-screen 510 of the “CallAhead” state 332 are inherited from the “Working” state's Laptop “Action A” 533 shown in FIG. 27.

After entering the “Call Ahead” state 332 into the modified state flow 2400 the State Flow Editor may alert the user that the preceding “Working” state 330 requires reconfiguration to incorporate the added “Call Ahead” state 332 transition option.

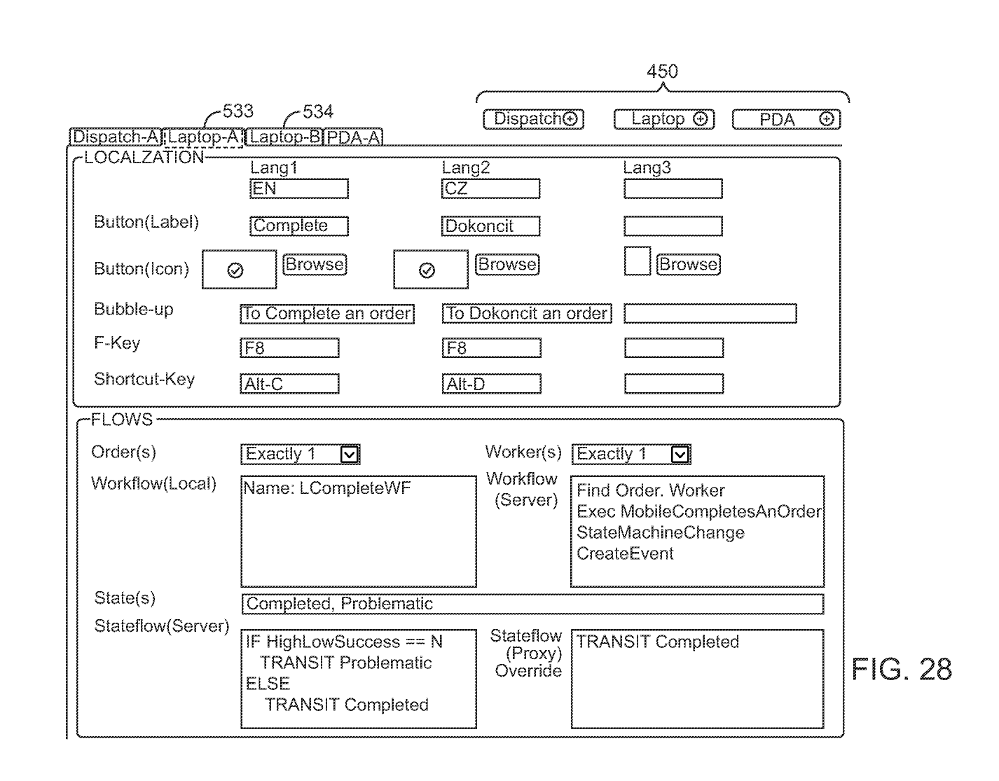

FIG. 27 shows the properties for the “Working” state's 330 Action Triggers Clients sub-screen 510 which have been reconfigured to incorporate the “CallAhead” state 332 option in addition to the previous configuration for the “Complete” option for the Laptop worker type 532. FIG. 27 illustrates the configuration of multiple worker actionable transitions that are available for the Laptop worker type 532. Referring to FIG. 28 the Action Triggers Client sub-screen 510 provides options 560 that enable the user to add and configure multiple worker actionable transitions for each worker type. A second worker actionable transition named “Laptop B” 534 is created for the laptop worker type.

Details of the Laptop worker type's multiple worker actionable transitions are shown in FIG. 27. A Laptop worker 532 may select “Action A” 533 to trigger the work order to transition to the “Complete” state 350. The Button (label) 511, Button (Icon) 512, Bubble-up 513, F-Key 514 and Shortcut-key 515 elements are configured with the appropriate text and graphic icons to represent and trigger the “Complete” functions of “Action A” 533.

The Order(s) element 516 and the Worker(s) element 517 under “Action A” 533 are configured with a parameter of “Exactly 1”.

The Workflow (local) element 518 under “Action A” 533 is assigned with the workflow file “LCompleteWF” which is executed on the laptop when the defined action trigger button 512, F-Key 514 or defined Shortcut-Key 515 for the “Complete” function is selected on a laptop 532. The user may use a pointing device to double click on the “LCompleteWF” file name in the Workflow (local) element 518 to select an alternative file from a list of available workflow files.

The Workflow (Server) element 519 under “Action A” 533 shows the actions that will be executed by server 101 when the laptop 533 triggers the “Complete” function for “Action A” 533, which include “Find Order, Worker”, “Execute MobileCompletesAnOrder”, “StateMachineChange”, and “CreateEvent”.

The State flow (server) element 521 under “Action A” 533 shows the decision logic that is executed to determine whether the work order should subsequently transition to the “Problematic” state 340 or the “Completed” state 350. The user may double click on the logic statements to open the State Flow Editor 370 to edit the state flow logic.

A worker may alternatively employ the laptop's “Action B” 534 action triggers to implement the “Call Ahead” functions. The Button (label) 511, Button (Icon) 512, Bubble-up 513, F-Key 514 and Shortcut-Key 515 elements are configured with the appropriate text and graphic icons to represent and trigger the “Call Ahead” functions of “Action B” 534.

The Workflow (local) element 518 under “Action B” 534 is assigned with the workflow file “LCallAheadWF” which is executed on the laptop 532 when the defined action trigger Button (Icon) 512, F-Key 514 or defined Shortcut-Key 515 for the “Call Ahead” function is selected on the laptop 532. The user may use a pointing device to double click on the “LCallAheadWF” file name in the Workflow (local) element 518 to select an alternative file from a list of available workflow files.

The Workflow (Server) element 519 under “Action B” 534 shows the actions that are to be executed by server 101 when the laptop 532 triggers the “Call Ahead” functions for “Action B” 534, which include “Find Order, Worker”, “Execute MobileCallAheadAnOrder”, “StateMachineChange”, and “CreateEvent”.

The State flow (server) element 521 under “Action B” 534 shows that the subsequent transition state is configured with the “CallAhead” state 332 as shown in FIG. 27. The user may double click on the “CallAhead” state in the State flow (server) element 521 to open the State Flow Editor 370 to edit the state flow logic.

Once defined, the state definitions and the state flow logic may be stored in database 105 for use by the system when processing a specified type of business process.

Multiple state flows with independently configured order states may be created for business entities that perform a plurality of business processes.

The state definitions and state flow logic for each business process forms part of a data entity referred to as an “Order Type”. An order type includes the relevant data for a particular business process and is stored in database 105 for use when called by the system.

An Order Type also defines the workflow files that may be executed on a desktop client 115, mobile devices 130, and/or the server 101. Workflow files include definitions for the dispatcher screens, mobile device workflow screens, data fields, and workflow logic. A plurality of workflow files may be commonly defined for use on all client devices, and may be independently defined for particular types of client devices, or independently defined for a particular client device.

The GUI configuration tool integrates the Order Type state flow definitions and decision logic as executable constructs that are made available to the application software. New and/or edited Order Type definitions are interpreted by the application, without requiring the re-writing or re-compiling of the application software and without interrupting the operability of the application at any time.

The system, when integrating state flow definitions and logic, may use a programming language based on Extensible Markup Language (XML), which provides programming constructs such as variables, conditions, operations, loops and custom actions, and allows users to employ variables and global variables to assist in the logic. The language is loaded as an XML document when the user uploads changes to database 105.

The system may use Document Object Model (DOM) methods to traverse the state flow logic. The system uses the DOM to execute the XML instructions as defined by the logic.

A project, intended to be common amongst desktop 115, mobile device 130 and server 115, is written once and compiled for either desktop 115, mobile device 130, or server 101 use. The common project then reads the XML definition for the document and allows the clients to utilize the document and workflow. A client application program de-serializes the XML code into objects that can logically evaluate the XML command nodes. The application loads the relevant document files at start up and reloads updated files when notified.

In an example embodiment the system uses a build process that takes the GUI tool output, and compiles and links the modules. The GUI output feeds an upload process into the database schema. The process builds and uploads multiple order types. The build tool and database schema deals with both pre-defined or business rule fields, as well as user-defined fields, specific to each user-defined solution file.

The Structured Query Language (SQL) Server, or Oracle™ database's Extensible Markup Language (XML) component can define and encapsulate the customer-defined fields as a single large XML data string within one field of the database. This method hides the complexity and variability of these fields.

An XML query language, such as XQuery, that is designed to use the structure of XML to express queries across all kinds of data stored or expressed as XML, may be used to extract and process the user-defined fields in an efficient manner from database 105.

The build process employs XML data to decouple the solution file and hide the complexity of the user-defined fields from the build process. This method provides a reliable and efficient build process that prevents overly complex builds.

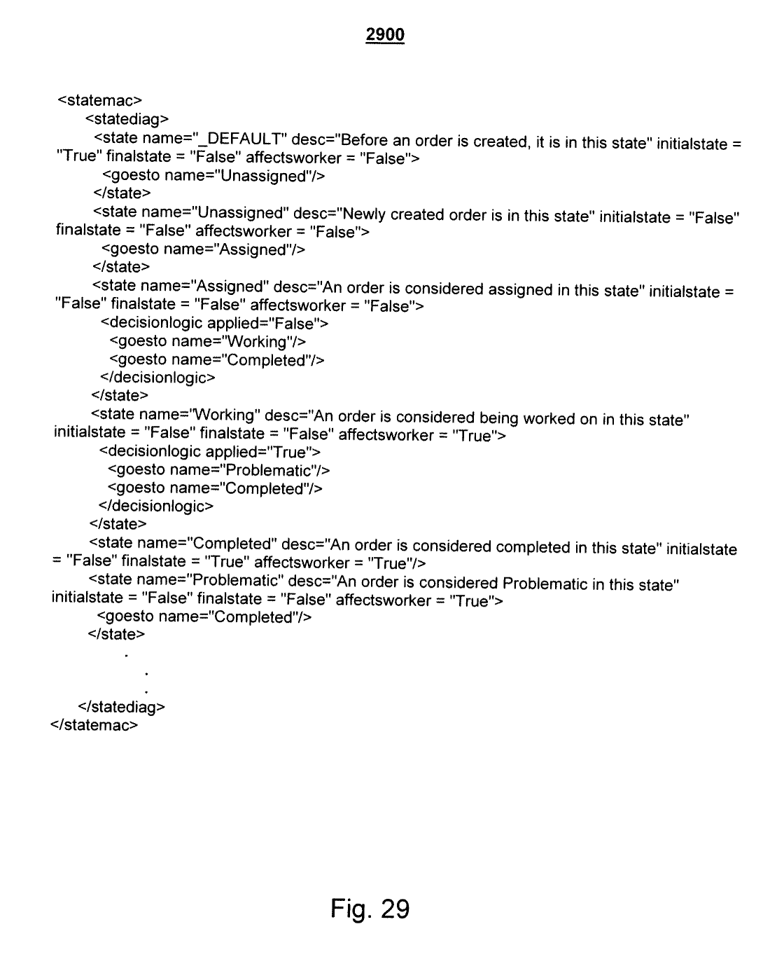

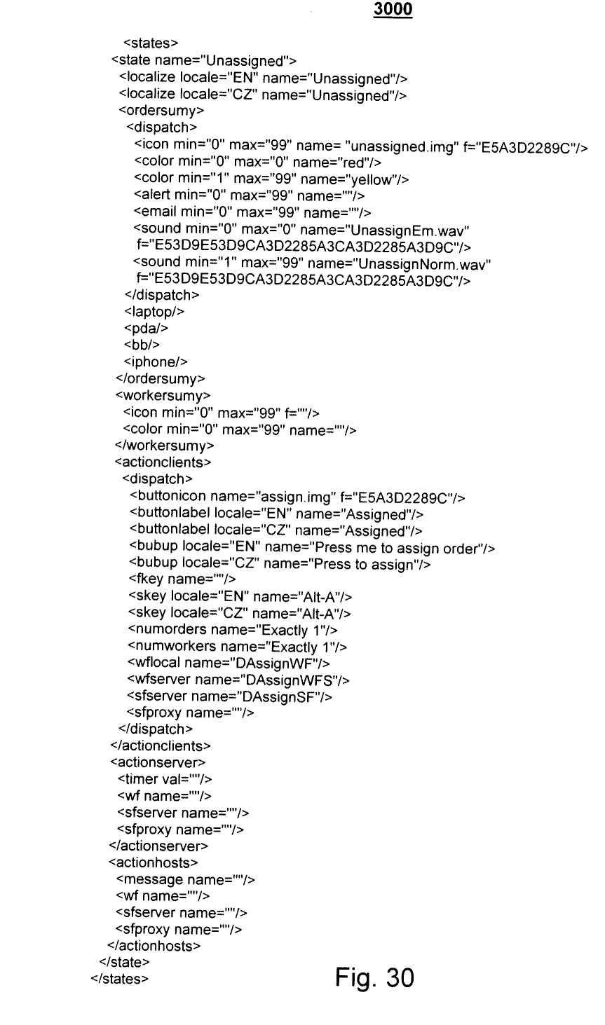

FIG. 29 shows an example of code 2900 illustrating the methodology for defining a state flow within an Order Type. FIG. 30 shows an example of code 3000 that illustrates the methodology for defining order state properties within an Order Type.

The workflow management system presented herein allows worker statuses to be configurable and represented within the system. Worker statuses are used to indicate the status of a worker during any worker state. Worker statuses may include “Available”, “Unavailable”, “Lunch”, “Break”, “Emergency”, and “Out-of-range”, which may be used to indicate a worker's availability for scheduling and work assignment, temporary unavailability due to meal and rest breaks, the need for emergency assistance, and their network communication status. Worker states are used by the system and dispatchers to track and manage worker activities. Referring to FIG. 23, Worker states may include a plurality of predefined states such as “Signed-off” 2340, “Signed-on” 2345, and inherit particular order states from the processing of work orders, such as “Working” 330. Worker state transitions may be triggered by order state transitions where an order state is configured with “Affect Worker State” option 417. In another embodiment worker state transitions may be triggered by action triggers and decision logic that are configured by a user through a Worker State Editor.

A plurality of worker statuses may be provided to workers on client devices for selection and activation by the workers. Worker statuses may be independently configured to allow workers to select and activate particular worker statuses independently from worker states.

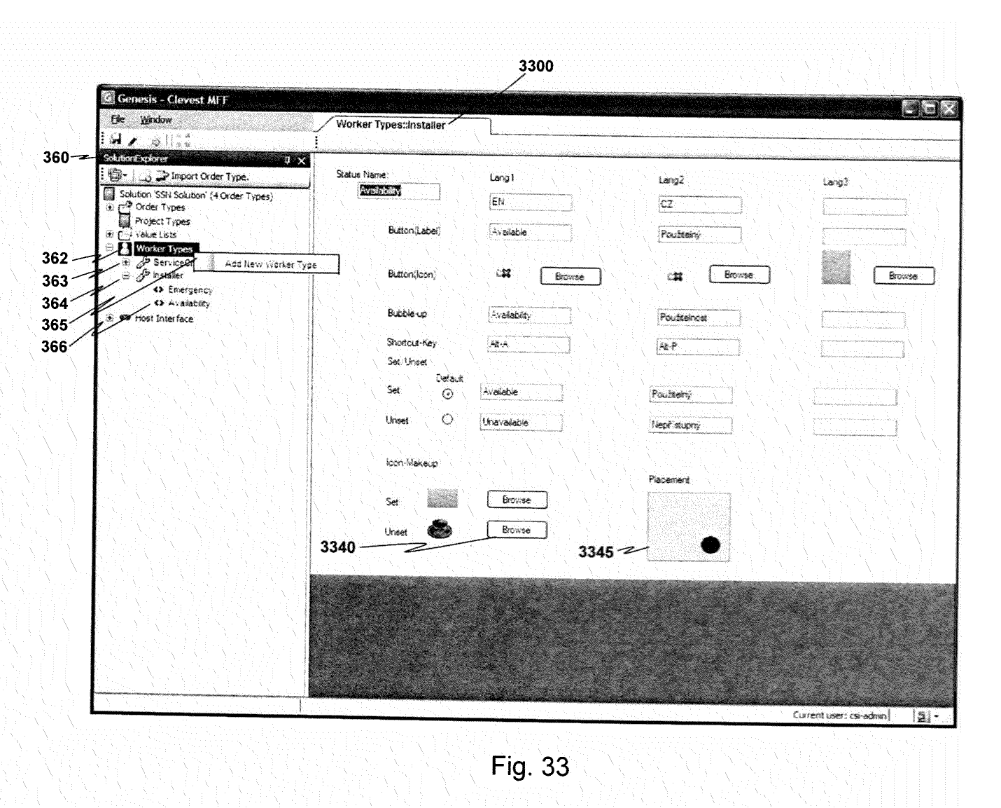

Worker types and worker status properties are configured through a Worker Detail Editor 3300 illustrated in FIG. 33. The user may open the Worker Detail Editor 3300 by selecting the Worker Types option 362 in the GUI tool's function menu 360. The user may right click on the Worker Types option 362 to display an optional function for “Add New Worker Type” 365 to create and configure new worker types. The example shows worker types named “ServiceCrew” 363 and “Installer” 364.

Users may configure the name and graphic representations, restrictions, and actions that are involved for each worker status within each worker type. FIG. 33 shows the configuration of the “Availability” 366 worker status for the “Installer” 364 worker type. The Worker Detail Editor 3300 allows users to add or delete graphic icons and also overlay graphics over graphic icons to represent particular worker statuses during particular worker states. Configuring graphics to represent a particular worker status during a particular worker state may be accomplished by selecting the use of a worker status graphic icon from a list of available graphic icons 3340 and superimposing or juxtaposing the graphic icon with a particular worker state icon displayed on client devices. Users may also configure the position of the worker status graphic icons on client devices by selecting a position from a graphic display of available positions 3345.

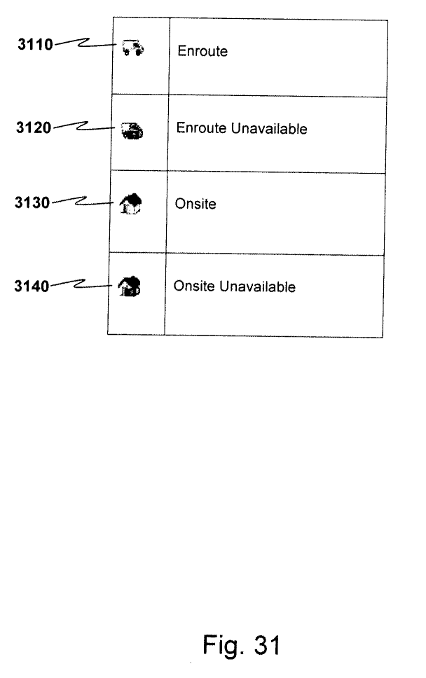

FIG. 31 illustrates examples of graphic icons that may be used to represent worker states and worker statuses on a client device. Graphic icons for an “Enroute” worker state 3110, and “Onsite” worker state 3130 are provided. To indicate that a worker is unavailable during the “Enroute” worker state 3110 and the “Onsite” worker state 3130 an “Enroute-Unavailable” icon 3120 and an “Onsite-Unavailable” icon 3140 are also provided. The graphic icons for the “Enroute-Unavailable” 3120 and the “Onsite-Unavailable” 3140 statuses are created through the Worker Detail Editor by superimposing a particular graphic over the icons for the “Enroute” worker state 3110, and “Onsite” worker state 3130.

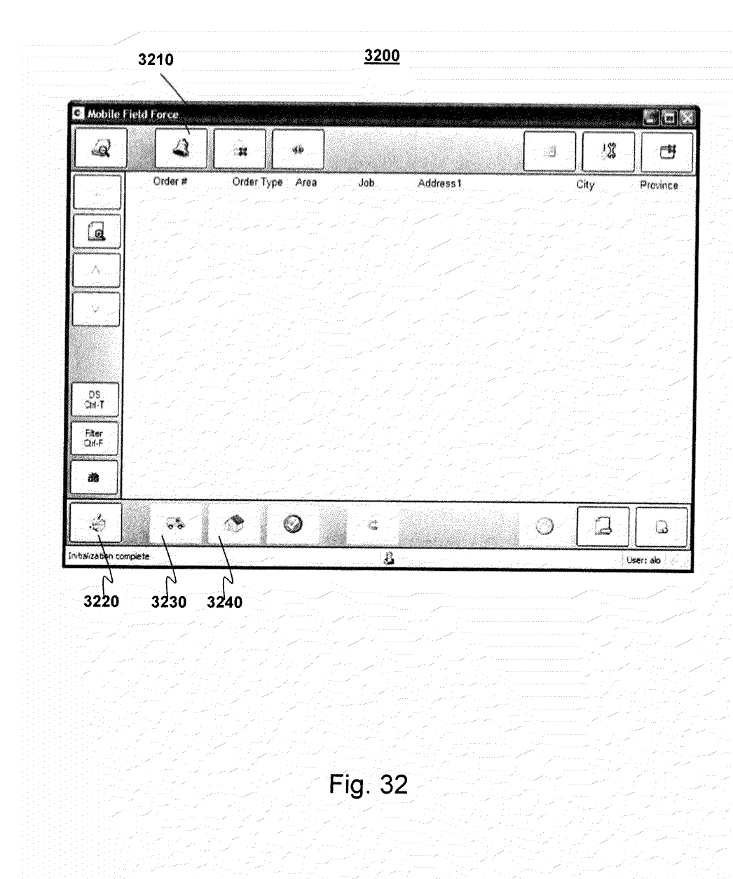

FIG. 32 illustrates worker status options that may be displayed on a worker's laptop device, which include “Enroute” 3220, “Onsite” 3230, “Complete” 3240, and “Emergency” 3210.

Worker type definitions, worker status properties, graphic icons, worker state definitions, and worker state decision logic, are saved as a data entity referred to as a “Worker Type” and stored in database 105. The Worker Type data entity is created and applied by the system in the same manner as the Order Type data entity. Multiple Worker Types with independently configured worker type definitions, worker status properties, graphic icons, worker state definitions, and worker state decision logic may be created to satisfy the needs of businesses that employ a plurality of worker types.

The GUI configuration tool integrates the Worker Type's properties and decision logic as executable constructs that are made available to the application software. New and edited Worker Type definitions are interpreted by the application, without requiring the re-writing or re-compiling of the application software and without interrupting the operability of the application at any time.

The system integrates Worker Type definitions and logic using programming language based on Extensible Markup Language (XML), which provides programming constructs such as variables, conditions, operations, loops and custom actions and allows users to employ variables and global variables to assist in the logic. The language is loaded as an XML document when the user uploads changes to database 105.

The system may use DOM methods to traverse the Worker Type definitions and decision logic. The system uses the DOM to execute the XML instructions as defined by the logic.

The common project is written once and compiled for either desktop 115, mobile device 130, or server 101 use. The common project then reads the XML definition for the document and allows the client device to utilize the document and workflow. A client application program de-serializes the XML code into objects that are able to logically evaluate the XML command nodes. The application loads the relevant document files at start up and reloads updated files when notified.

In an example embodiment the system uses a build process that takes the GUI tool output, and compiles and links the modules. The GUI output feeds an upload process into the database schema. The process builds and uploads multiple Worker Types.

Work orders may involve multiple workers which may create a scenario wherein multiple workers submit the same action trigger for the same order state transition within the state flow. The Action Triggers sub-screens 410 and 610 in the State Editor allow the system to accommodate multiple worker scenarios by enabling the user to configure the appropriate system response to multiple worker inputs.

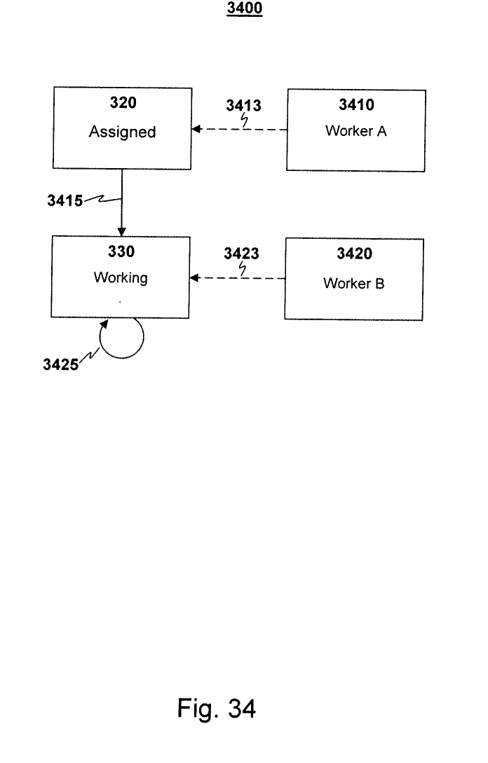

FIG. 34 illustrates a state flow 3400 wherein two workers are required to process the same work order. Each worker indicates that they have begun to process a particular work order through their mobile device 130. When Worker A 3410 engages in the processing of the work order by entering the associated action trigger 3413 on a mobile device 130, the server 101 transitions the work order from an “Assigned” state 320 to a “Working” state 330, logs the worker's start time, and transitions the worker's worker state to a “Working” state 330. When Worker B 3420 engages in the processing of the work order by entering the associated action trigger 3423 on a mobile device 130, the server 101 refers to the definitions that are configured in the Action Triggers sub-screens 510 and 610 of the Order State Editor which is configured with state flow logic that retains the work order in the “Working” state 330. The server 101 transitions the second worker's worker state to a “Working” state 330 and logs the second worker's start time.

The extensible workflow management system presented herein is also capable of integrating customer specific functions and features including the use of third party application program interfaces (APIs) to invoke and/or control third party hardware 135 that is outside of the workflow management system.

Custom functions and features are provided in a form of extensible code. In this document the term “extensible code” refers to programming code used to implement third party functions and features including hardware functionality with the system.

Extensible code may be provided in the form of a Dynamic Link Library (DLL) that is written by an in-house programmer or by a third party developer. Custom functions are created according to a published interface and may be stored as a DLL in a specified directory prior to execution. The DLL is retrieved for execution when a state flow calls for a custom function.

The system's published interface allows the execution of custom functions at particular points of a state flow that may be executed on a server or client. Custom functions may be validation rules, or complex functions that allow the system to consume Web Services, access or update a database, and other programmable executions. The interface also allows the system to integrate any third party hardware device that can communicate through hardware interfaces, such as Serial Port, Universal Serial Bus (USB), Bluetooth, and Infra Red.

The following is an example of an interface that allows the use of custom code for the “Call Ahead” function:

```
OnStateChange:
{ If (Old_State==”Working”)
    { If (New_State==”Call Ahead”)
    {Call webservice to send a VOIP call to phone number
    of the work order
    }
    }
}
```

When the worker selects the call ahead function the server identifies a custom DLL and executes the DLL methods. Upon completing the DLL methods the work order transitions from the current state to the subsequent state as defined by the state flow. The extensible workflow management system presented herein is also capable of integrating customer specific functions for implementation at particular processing states or state transitions of work orders. A processing state may be understood as a particular event or state of processing a work order, including the assignment, scheduling, completion, cancellation, status change, or uploading of a work order. Custom functions that are designed to be executed at particular processing states of a work order are referred to as Order Event Logic.

Order Event Logic is integrated into the system as extensible code. Order Event Logic is designed to meet the specific requirements of a particular business and may be created by in-house developers or third party programmers. The system provides an interface referred to as an OrderTypeHelper to allow the code to be integrated with the system by exposing specific classes and methods.

The following is an example of an interface that allows the integration of Order Event Logic on the system server:

```
    namespace Clevest.Business.OrderEventLogic
    {
      public class OrderTypeHelper : BaseOrderTypeHelper,
IOrderTypeHelper OnStateChange:
{ If (Old_State==”working”)
    { If (New_State==”Call Ahead”)
    {Call webservice to send a VOIP call to phone number
    of the work order
    }
    }
}
```

The above interface allows the execution of custom functions at particular points of a state flow that may be executed on server 101. Custom functions may be validation rules, or complex functions that allow the system to consume Web Services, access or update a database, and other programmable executions.

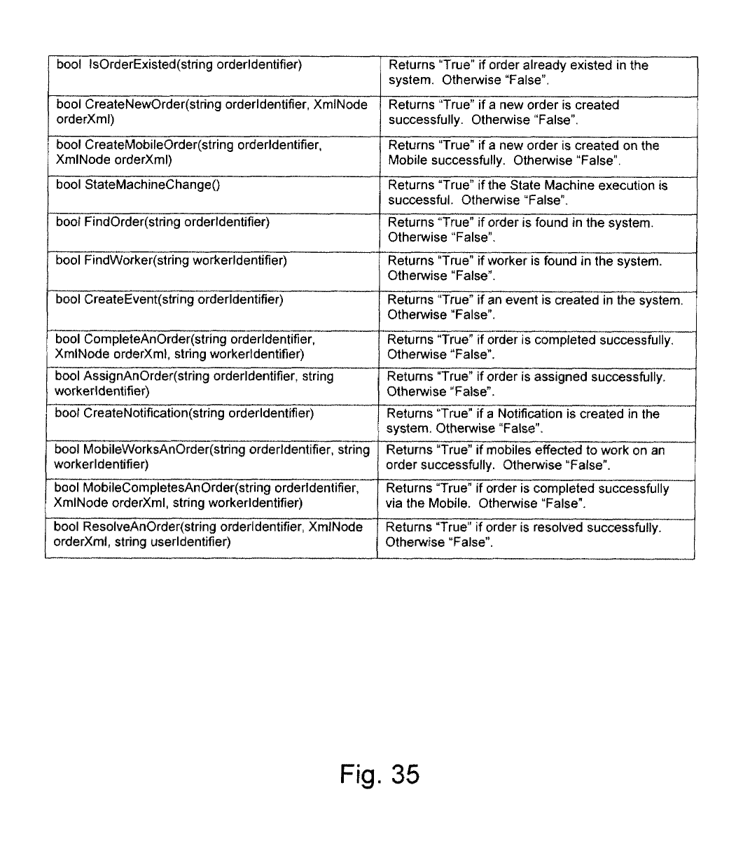

FIG. 35 shows examples and definitions of published interfaces that may be used by the system to integrate custom functions. The published interfaces enable developers to create and implement custom functions and features that are not regularly configurable through the GUI configuration tool and without the need to rewrite the application.

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, or execute acts in a different order than set out in the illustrated embodiments.

The present methods, systems and articles also may be implemented as a computer program product that comprises a computer program mechanism embedded in a computer readable storage medium. For instance, the computer program product could contain program modules for installing and operating the applications described above. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and applications via the use of examples. Insofar as such examples contain one or more functions or operations, it will be understood by those skilled in the art that each function or operation within such examples can be implemented, individually and/or collectively, by a wide range of hardware, software, firmware, or virtually any combination thereof. In one embodiment, the present subject matter may be implemented via Application-Specific Integrated Circuits (ASICs). However, those skilled in the art will recognize that the embodiments disclosed herein, in whole or in part, can be equivalently implemented in standard integrated circuits, as one or more computer programs running on one or more computers, as one or more programs running on one or more controllers (e.g., microcontrollers) as one or more programs running on one or more processors (e.g., microprocessors), as firmware, or as virtually any combination thereof, and that designing the circuitry or writing the code for the software and or firmware would be well within the skill of one of ordinary skill in the art in light of this disclosure.

In addition, those skilled in the art will appreciate that the applications taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

Further, in the methods taught herein, the various acts may be performed in a different order than that illustrated and described. Additionally, the methods can omit some acts, and/or employ additional acts.

These and other changes can be made to the present systems, methods and applications in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

What is claimed is:

1. A system for implementing a work flow for a plurality of workers, comprising:
a database storing a plurality of order states, a plurality of worker states, a worker state decision logic, a plurality of worker types, a plurality of worker statuses, a plurality of data fields, a plurality of repeatable fields, an executable construct corresponding to a state flow, and an executable construct corresponding to a worker state decision logic;
a first application program integrating one of said order states, one of said worker states, said worker state decision logic, one of said worker statuses, and a state flow logic; and
a second application program executing said state flow logic and said worker state decision logic.

2. The system of claim 1 wherein said plurality of order states, plurality of worker states, plurality of worker types, plurality of worker statuses, plurality of data fields, and plurality of repeatable fields are stored as Extensible Markup Language (XML) code in said database.

3. The system of claim 1 wherein a representation of said state flow logic is presented in a spoken language syntax convertible into XML code that is stored in said database and made available to said first and second application programs.

4. The system of claim 1 wherein a representation of said order states, worker types, worker states, and worker statuses are converted into XML code that are stored in said database and made available to said first and second application programs.

5. A graphical user interface tool for creating and editing a plurality of order states, a plurality of worker states, a worker state decision logic, a plurality of worker types, a plurality of worker statuses, a plurality of state flows, and a state flow logic comprising:
a screen area wherein the state flow is editable;
a screen area wherein the state flow logic is editable;
a screen area providing a context sensitive menu of a plurality of state flow components presented with graphical elements and spoken language syntax for use in editing the state flow;
a screen area providing a context sensitive menu of a plurality of components for the state flow logic, the components presented in spoken language syntax for use in editing the state flow logic;
a screen area providing a context sensitive menu of said plurality of order states, said plurality of data fields, and said plurality of repeatable fields useable to create a state flow logic statement for said state flow logic;
a screen area wherein one of said plurality of order states is editable and a new order state is creatable;
a screen area providing a context sensitive menu of a plurality of components for said order states, said components presented with graphical elements and in spoken language syntax for use in editing the order state properties;
a screen area wherein a worker type and the worker type properties are creatable and editable;
a screen area providing a context sensitive menu of a plurality of components of said worker types, said components presented with graphical elements and in spoken language syntax for use in editing the worker type properties;
a screen area wherein said worker states are creatable and editable;
a screen area providing a context sensitive menu of a plurality of components for said worker states, said components presented with graphical elements and in spoken language syntax for use in editing properties of said worker states;
a screen area wherein worker state decision logic are creatable and editable;
a screen area providing a context sensitive menu of a plurality of components of said worker state decision logic, said components presented in spoken language syntax for use in editing the worker state decision logic;
a screen area providing a context sensitive menu of said pluralities of worker states, order states, data fields, and repeatable fields useable to create a worker state decision logic statement for said worker state decision logic;
a screen area wherein one of said plurality of worker statuses is creatable and editable; and
a screen area providing a context sensitive menu of a plurality of components of said worker statuses, said components presented with graphical elements and in spoken language syntax for use in editing the worker status properties.

6. The graphical user interface of claim 5 wherein said state flow logic is editable by inclusion of one of said order states, said data fields, and said repeatables that is added to a database accessible by the graphical user interface tool.

7. The graphical user interface of claim 5 wherein said worker state decision logic is editable by inclusion of one of said order states, said worker states, said data fields, and said repeatables that is added to a database accessible by the graphical user interface tool.

8. The graphical user interface of claim 5 wherein the state flow logic is editable to include a plurality of, and arrangement of, one of said order states, data fields and repeatables.

9. The graphical user interface of claim 5 wherein the state flow logic is editable by replacing said state flow logic statement with a second state flow logic statement.

10. The graphical user interface of claim 5 wherein the state flow logic is further editable by generation of a second state flow logic statement and inclusion of a second order state of said database.

11. The graphical user interface of claim 5 wherein the state flow logic is editable by generation of the state flow logic including an arrangement of one selected from the group consisting of operators, functions, said order states, and said data fields, that is provided within a context sensitive menu.

12. The graphical user interface of claim 5 wherein the state flow logic is editable by provision of a construct for applying a while loop.

13. The graphical user interface of claim 5 wherein the worker state decision logic is further editable by replacing the worker state decision logic statement with a second worker state decision logic statement.

14. The graphical user interface of claim 5 wherein the worker state decision logic is further editable to include a plurality of, and arrangement of, said order states, worker states, data fields and repeatables.

15. The graphical user interface of claim 5 wherein the worker state decision logic is editable by generation of a second worker state decision logic statement and inclusion of a second order state and worker state of said database.

16. The graphical user interface of claim 5 wherein the worker state decision logic is editable by generation of said worker state decision logic including one selected from the group consisting of operators, functions, order states, worker states, and data fields, that is provided within a context sensitive menu.

17. The graphical user interface of claim 5 wherein said worker state decision logic is editable by provision of a construct for applying a while loop.

18. The graphical user interface of claim 5 wherein said screen area is dynamically updated to correspond to a change to one of said order states, worker types, worker states, or worker statuses in said database.

19. The graphical user interface of claim 5 wherein a construct is provided for applying logic tests to all of said order states, worker states, data fields, fields in a repeatable, and fields within said repeatable that are one level nested within said repeatable.

20. A method of managing a state flow comprising a plurality of order states, comprising the steps of:
a) providing a graphic user interface wherein a plurality of configurable properties are selectable;
a) providing means to configure said properties for each of said order states;
wherein said state flow is dynamically updated in response to configuration of said order states.

21. The method of claim 20 wherein said state flow further comprises a state flow logic, and wherein said state flow logic is configured using said graphical user interface and said state flow is dynamically updated in response to said configuration of said state flow logic.

22. The method of claim 21 further comprising the step of providing a plurality of optional actions wherein each of said actions triggers an order state transition within said state flow.

23. The method of claim 22 further comprising the step of providing input from a plurality of action triggers, each of said action triggers triggering said order state transition in said state flow, said action triggers received from a plurality of workers, each of said workers engaged in a work order.

24. The method of claim 23 further comprising the step of providing a temporal trigger for configuring said state flow.

25. The method of claim 24 further comprising the step of providing means for adding, configuring and deleting a plurality of worker types in conjunction with said state flow logic of said state flow.

26. The method of claim 25 further comprising the step of providing a plurality of worker states, said worker states working in conjunction with said state flow and said state flow logic.

27. The method of claim 26 further comprising the step of configuring said worker statuses.

28. The method of claim 27 wherein said graphic user interface provides a plurality of overlaying graphic icons to configure graphic representations of said workers statuses.

29. The method of claim 28 further comprising the step of configuring descriptions for order states, order state elements, worker types, worker states, worker state elements, and worker statuses in a plurality of languages.

30. The method of claim 29 further comprising the step of organizing data for said state flow, including said order state properties of said state flow, said state flow logic, server actions, and client device actions into a data object that is stored in a database and made available to an application software as an executable construct.

31. The method of claim 30 further comprising the step of organizing data for said worker types, said worker states, a worker state decision logic and worker statuses of a workflow, into a second data object that is stored in said database and made available to said application software as a second executable construct.

32. The method of claim 31 further comprising the step of integrating extensible code with an interface allowing customer specific functions to be executed at a processing point of said state flow on mobile devices.

33. The method of claim 31 further comprising integrating extensible code with an interface to allow third party hardware functionality to be executed at a transition point of said state flow.
